(19) United States
(12) Patent Application Publication
(10) Pub. No.: US 2023/0273941 A1
(43) Pub. Date: Aug. 31, 2023

(54) USER INTERFACE FOR ANALYZING DATA BASED ON VISUALIZATION FEATURES

(71) Applicant: Tableau Software, LLC, Seattle, WA (US)

(72) Inventors: Rachel Stern Kalmar, Cambridge, MA (US); Mark Siegel, Vancouver (CA); Lara Thompson, Vancouver (CA)

(21) Appl. No.: 17/588,820

(22) Filed: Jan. 31, 2022

(51) Int. Cl. G06F 16/28; G06F 16/26; G06N 5/04

(52) U.S. Cl. CPC G06F 16/287; G06F 16/26; G06N 5/045

(57) ABSTRACT

Embodiments are directed to visualizations. A visualization may be provided based on data from a data source such that the visualization includes marks that are associated with from the data source. A mark-of-interest may be determined from the marks based on characteristics of the marks or the visualization. A snapshot of the data may be generated from the data source that may be associated with the visualization and a time that the mark-of-interest is determined. Mark evaluators may be employed to generate evaluation results based on the mark-of-interest and the snapshot data such that the evaluation results may include an explanation narrative or an explanation visualization and such that each evaluation result may be associated with scores that may be based on the evaluation. Evaluation results may be ordered based on their association with the scores. A report that includes the evaluation results may be provided.

### TECHNICAL FIELD

The present invention relates generally to data visualization, and more particularly, but not exclusively, to analyzing data based on visualizations.

### BACKGROUND

Organizations are generating and collecting an ever increasing amount of data. This data may be associated with disparate parts of the organization, such as, consumer activity, manufacturing activity, customer service, server logs, or the like. For various reasons, it may be inconvenient for such organizations to effectively utilize their vast collections of data. In some cases, the quantity of data may make it difficult to effectively utilize the collected data to improve business practices. Accordingly, in some cases, organizations may employ various applications or tools to generate visualizations based on some or all of their data. Employing visualizations to represent data may enable organizations to improve their understanding of business operations, sales, customer information, employee information, key performance indicators, or the like. However, in some cases, visualizations may include marks, signal, values, or the like, that may seem out of place or otherwise anomalous. In some cases, determining the source or otherwise analyzing these the source or cause of such marks may require a in depth understanding of the underlying data that was used to generate the visualizations. Disadvantageously, this may require organizations to employ skilled or specialized data analysts to review the visualization and data to determine an explanation for why the mark may have a given value. Also, in some cases, even if the user has the skills or technical background to perform their own analysis, the underlying data may be sensitive or otherwise inaccessible to users that may be reviewing the visualizations.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a logical architecture of a system for analyzing data based on visualization features in accordance with one or more of the various embodiments;

FIG. 2 illustrates a logical representation of a portion of a visualization in accordance with one or more of the various embodiments;

FIG. 3 illustrates a logical representation of a portion of a mark evaluation system in accordance with one or more of the various embodiments;

FIG. 4 illustrates a logical representation of a user interface for viewing or interacting with visualizations in accordance with one or more of the various embodiments;

FIG. 5A illustrates a logical representation of a user interface for analyzing data based on visualization features in accordance with one or more of the various embodiments;

FIG. 5B illustrates a logical representation of a user interface for analyzing data based on visualization features in accordance with one or more of the various embodiments;

FIG. 6 illustrates a logical schematic of a portion of a system for analyzing data based on visualization features in accordance with one or more of the various embodiments;

FIG. 7 illustrates a logical schematic of a mark evaluator for analyzing data based on visualization features in accordance with one or more of the various embodiments;

FIG. 8 illustrates an overview flowchart of a process for analyzing data based on visualization features in accordance with one or more of the various embodiments;

FIG. 9 illustrates a flowchart of a process for analyzing data based on visualization features in accordance with one or more of the various embodiments;

FIG. 10 illustrates a flowchart of a process for analyzing data based on visualization features in accordance with one or more of the various embodiments;

FIG. 11 illustrates an overview flowchart for a process for user interfaces for analyzing data based on visualization features in accordance with one or more of the various embodiments;

FIG. 12 illustrates a flowchart for a process for user interfaces for analyzing data based on visualization features in accordance with one or more of the various embodiments;

FIG. 13 illustrates a flowchart for a process for user interfaces for analyzing data based on visualization features in accordance with one or more of the various embodiments;

FIG. 14 illustrates a flowchart for a process for user interfaces for analyzing data based on visualization features in accordance with one or more of the various embodiments;

FIG. 15 illustrates a flowchart for a process for user interfaces for analyzing data based on visualization features in accordance with one or more of the various embodiments;

FIG. 16 shows components of one embodiment of an environment in which embodiments of the invention may be practiced in accordance with one or more of the various embodiments;

FIG. 17 shows one embodiment of a client computer in accordance with one or more of the various embodiments; and

FIG. 18 shows one embodiment of a network computer that may be included in a system implementing one or more of the various embodiments in accordance with one or more of the various embodiments.

### DETAILED DESCRIPTION OF THE VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein, the term “engine” refers to logic embodied in hardware or software instructions, which can be written in a programming language, such as C, C++, Objective-C, COBOL, Java™, Kotlin, PHP, Perl, JavaScript, Ruby, VBScript, Microsoft .NET™ languages such as C#, or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine. Also, in some embodiments, one or more portions of an engine may be a hardware device, ASIC, FPGA, or the like, that performs one or more actions in the support of an engine or as part of the engine.

As used herein, the term “data model” refers to one or more data structures that represent one or more entities associated with data collected or maintained by an organization. Data models are typically arranged to model various operations or activities associated with an organization. In some cases, data models are arranged to provide or facilitate various data-focused actions, such as, efficient storage, queries, indexing, search, updates, or the like. Generally, a data model may be arranged to provide features related to data manipulation or data management rather than providing an easy to understand presentation or visualizations of the data.

As used herein, the term “data object” refers to one or more entities or data structures that comprise data models. In some cases, data objects may be considered portions of the data model. Data objects may represent classes or kinds of items, such as, databases, data-sources, tables, workbooks, visualizations, work-flows, or the like.

As used herein, the term “data object class” or “object class” refers to a one or more entities or data structures that represent a class, kind, or type of data objects.

As user herein the “visualization model” refers to one or more data structures that represent one or more representations of a data model that may be suitable for use in a visualization that is displayed on one or more hardware displays. In some cases, visualization models may define styling or user interface features that may be made available to non-authoring user.

As used herein, the term “display object” refers to one or more data structures that comprise visualization models. In some cases, display objects may be considered portions of the visualization model. Display objects may represent individual instances of items or entire classes or kinds of items that may be displayed in a visualization. In some embodiments, display objects may be considered or referred to as views because they provide a view of some portion of the data model.

As used herein, the term “panel” refers to region within a graphical user interface (GUI) that has a defined geometry (e.g., x, y, z-order) within the GUI. Panels may be arranged to display information to users or to host one or more interactive controls. The geometry or styles associated with panels may be defined using configuration information, including dynamic rules. Also, in some cases, users may be enabled to perform actions on one or more panels, such as, moving, showing, hiding, re-sizing, re-ordering, or the like.

As used herein, the term “mark” refers to a distinct or otherwise identifiable portion of a visualization that may correspond to particular value or result in the visualization. For example, if a visualization includes a bar chart, one or more of the bars may be considered to be marks. Likewise, if a visualization includes a line plot, positions on the plot may be considered a mark.

As used herein, the term “mark-of-interest” refers to a mark in a visualization that has been selected from among the other marks included in the visualization. In some cases, marks in visualizations may incorporate one or more interactive features that may enable a user to select or identify one or more marks-of-interest from among the marks comprising a visualization. For example, a user may be enabled to select a mark-of-interest by right-clicking a mouse button while the mouse pointer may be hovering over a mark. In some cases, marks-of-interest may be selected via searching, filtering, or the like.

As used herein, the term “configuration information” refers to information that may include rule based policies, pattern matching, scripts (e.g., computer readable instructions), or the like, that may be provided from various sources, including, configuration files, databases, user input, built-in defaults, or the like, or combination thereof.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to visualization data using a network computer. In one or more of the various embodiments, a visualization may be provided based on data from a data source such that the visualization includes one or more marks that are associated with one or more values from the data source.

In one or more of the various embodiments, in response to a determination of a mark-of-interest from the one or more marks, a user-interface may be generated to display one or more evaluation results that may be associated with the mark-of-interest and performing further actions, including: displaying one or more explanation narratives that may be associated with the mark-of-interest; displaying one or more explanation visualizations that may be associated with the mark-of-interest such that the one or more explanation visualizations are separate from the visualization; in response to a selection of an explanation narrative, displaying one or more characteristics of the mark-of-interest that correspond to the explanation narrative; in response to a selection of an explanation visualization, displaying one or more other characteristics of the mark-of-interest that correspond to the explanation visualization; and in response to providing another visualization that includes one or more other marks, preserving the display of the one or more evaluation results that are associated with the mark-of-interest.

In one or more of the various embodiments, in response to a determination of another mark-of-interest, updating the display of the one or more evaluation results based on the other mark-of-interest.

In one or more of the various embodiments, displaying the one or more other characteristics of the mark-of-interest that correspond to the explanation narrative may include: displaying one or more additional explanation narratives based on an evaluation result that corresponds to the explanation narrative.

In one or more of the various embodiments, displaying the one or more other characteristics of the mark-of-interest that correspond to the explanation visualization may include: displaying one or more additional explanation visualizations based on an evaluation result that corresponds to the explanation visualization such that the one or more additional explanation visualizations include one or more interactive features that enable users to filter, expand, or view one or more of a value, a field, or a record from the data source that may be associated with the mark-of-interest.

In one or more of the various embodiments, generating the user-interface to display the one or more evaluation results may include: categorizing the one or more evaluation results based on the one or more characteristics of the mark-of-interest that correspond to the one or more evaluation results; and displaying one or more portions of the one or more explanation narratives in one or more portions of the user interface associated with one or more result categories.

In one or more of the various embodiments, generating the user-interface to display the one or more evaluation results may include: displaying a summary of one or more uniqueness attributes associated with the mark-of-interest; and in response to a selection of a uniqueness attribute, displaying an interactive visualization of the selected uniqueness attribute such that the interactive visualization enables a view of one or more of a value, a field, or a record associated with the uniqueness attribute or the mark-of-interest.

In one or more of the various embodiments, generating the user-interface to display the one or more evaluation results may include: providing a summary view that displays a summary of information associated with one or more of the mark-of-interest or the visualization such that the summary of information associated with the visualization, includes a view of the visualization scaled to fit within the user interface that displays the one or more evaluation results. In one or more of the various embodiments, in response to providing the other visualization, preserving the display of the scaled view of the visualization in the user interface.

Also, in one or more of the various embodiments, a visualization may be provided based on data from a data source such that the visualization includes one or more marks that are associated with one or more values from the data source.

In one or more of the various embodiments, a mark-of-interest may be determined from the one or more marks based on one or more characteristics of the one or more marks or the visualization.

In one or more of the various embodiments, a snapshot of the data may be generated from the data source that may be associated with the visualization and a time that the mark-of-interest is determined.

In one or more of the various embodiments, one or more mark evaluators may be employed to generate one or more evaluation results based on the mark-of-interest and the snapshot data such that the one or more evaluation results may include one or more of an explanation narrative, or an explanation visualization and such that each evaluation result may be associated with one or more scores that may be based on a fit to the snapshot data and the one or more marks absent the mark-of-interest.

In one or more of the various embodiments, the one or more evaluation results may be ordered based on their association with the one or more scores.

In one or more of the various embodiments, a report that includes the ordered list of the one or more evaluation results may be provided.

In one or more of the various embodiments, employing the one or more mark evaluators may include: providing one or more base models for each mark evaluator; determining a partial score for each mark evaluator based on its corresponding base model such that the partial score may be based on one or more values of the one or more marks absent the mark-of-interest; generating the one or more scores may be based on the partial score of the one or more base models.

In one or more of the various embodiments, employing the one or more mark evaluators may include: providing one or more explanation models for each mark evaluator; determining a partial score for each mark evaluator based on its corresponding explanation model such that the partial score may be based on the one or more values of the one or more marks absent the mark-of-interest and one or more other values from the data source; and generating the one or more scores based on the partial score of the one or more explanation models.

In one or more of the various embodiments, in response to another visualization that includes one or more other marks being displayed further actions may be performed, including: preserving the snapshot data and the mark-of-interest; and further employing the one or more mark evaluators to generate the one or more evaluation results based on the preserved snapshot data and the mark-of-interest.

In one or more of the various embodiments, employing the one or more mark evaluators, further comprises: providing one or more base models for each mark evaluator; employing each base model to predict one or more predicted values of the one or more marks absent the mark-of-interest; determining one or more prediction error values based on a comparison of the one or more values of the one or more marks and the one or more predicted values of the one or more marks; employing each base model to predict a value of the mark-of-interest for each base model; determining one or more mark-of-interest prediction error values based on a comparison of an actual value of the mark-of-interest and the predicted value of the mark-of-interest of each base model; and generating one or more base model partial scores based on the one or more prediction error values and one or more mark-of-interest prediction error values such that the one or more base model partial scores may be included in the one or more scores.

In one or more of the various embodiments, employing the one or more mark evaluators, may include: providing one or more explanation models for each mark evaluator; employing each explanation model to predict one or more predicted values of the one or more marks absent the mark-of-interest; determining one or more prediction error values based on a comparison of the one or more values of the one or more marks and the one or more predicted values of the one or more marks; employing each explanation model to predict a value of the mark-of-interest for each explanation model; determining one or more mark-of-interest prediction error values based on a comparison of an actual value of the mark-of-interest and the predicted value of the mark-of-interest of each explanation model; and generating one or more explanation model partial scores based on the one or more prediction error values and one or more mark-of-interest prediction error values such that the one or more explanation model partial scores may be included in the one or more scores.

In one or more of the various embodiments, determining the mark-of-interest from the one or more marks based on one or more characteristics of the one or more marks may include: excluding a portion of the one or more marks from the determination of the mark-of-interest based on one or more exclusionary characteristics such that the one or more exclusionary characteristics include one or more of a data type of the mark-of-interest, a filter rule, or the like.

### Illustrative Logical System Architecture

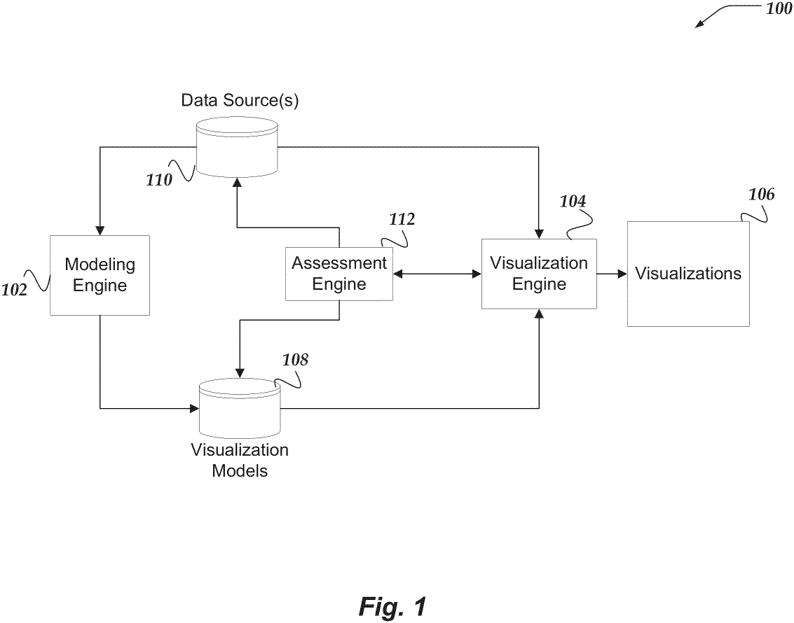

FIG. 1 illustrates a logical architecture of system 100 for user interfaces for analyzing data based on visualization features in accordance with one or more of the various embodiments. In one or more of the various embodiments, system 100 may be comprised of various components, including, one or more modeling engines, such as, modeling engine 102; one or more visualization engines, such as, visualization engine 104; one or more visualizations, such as, visualization 106; one or more data sources, such as, data source 110; one or more visualization models, such as, visualization model 108; or one or more evaluation engines, such as, evaluation engine 112.

In one or more of the various embodiments, modeling engine 102 may be arranged to enable users to design one or more visualization models that may be provided to visualization engine 104. Accordingly, in one or more of the various embodiments, visualization engine 104 may be arranged to generate one or more visualizations based on the visualization models.

In one or more of the various embodiments, modeling engines may be arranged to access one or more data sources, such as, data source 110. In some embodiments, modeling engines may be arranged to include user interfaces that enable users to browse various data sources, data objects, or the like, to design visualization models that may be used to generate visualizations of the information stored in the data sources.

Accordingly, in some embodiments, visualization models may be designed to provide visualizations that include charts, plots, graphs, tables, graphics, styling, explanatory text, interactive elements, user interface features, or the like. In some embodiments, users may be provided a graphical user interface that enables them to interactively design visualization models such that various elements or display objects in the visualization model may be associated with data from one or more data sources, such as, data source 110.

In one or more of the various embodiments, data sources, such as, data source 110 may include one or more of databases, data stores, file systems, or the like, that may be located locally or remotely. In some embodiments, data sources may be provided by another service over a network. In some embodiments, there may be one or more components (not shown) that filter or otherwise provide management views or administrative access to the data in a data source.

In one or more of the various embodiments, visualization models may be stored in one or more data stores, such as, visualization model storage 108. In this example, for some embodiments, visualization model storage 108 represents one or more databases, file systems, or the like, for storing, securing, or indexing visualization models.

In one or more of the various embodiments, visualization engines, such as, visualization engine 104 may be arranged to parse or otherwise interpret the visualization models and data from data sources to generate one or more visualizations that may be displayed to users.

In one or more of the various embodiments, evaluation engines, such as, evaluation engine 112 may be arranged to assess or otherwise evaluate marks in a visualization. Accordingly, in some embodiments, evaluation engines may be arranged to automatically provide an explanation for the value of a specific data point (e.g., mark). In one or more of the various embodiments, explanations about a mark may be conveyed to users as text strings and interactive visualizations, which be further explored.

In one or more of the various embodiments, evaluation engines may enable users to select one or more marks-of-interest from in visualization. Accordingly, in some embodiments, visualization engines may be arranged to generate visualizations that include interactive user interfaces features that enable a user to select a mark-of-interest. For example, in one or more of the various embodiments, visualization engines may be arranged to include an assess-this-mark command in a right-click context menu. Thus, in some embodiments, users may right-click on a display object that represents the mark-of-interest to bring up a context menu and then select the assess-this-mark command from the context menu. In other embodiments, users may be enabled to search for marks-of-interest using names or labels associated with a mark.

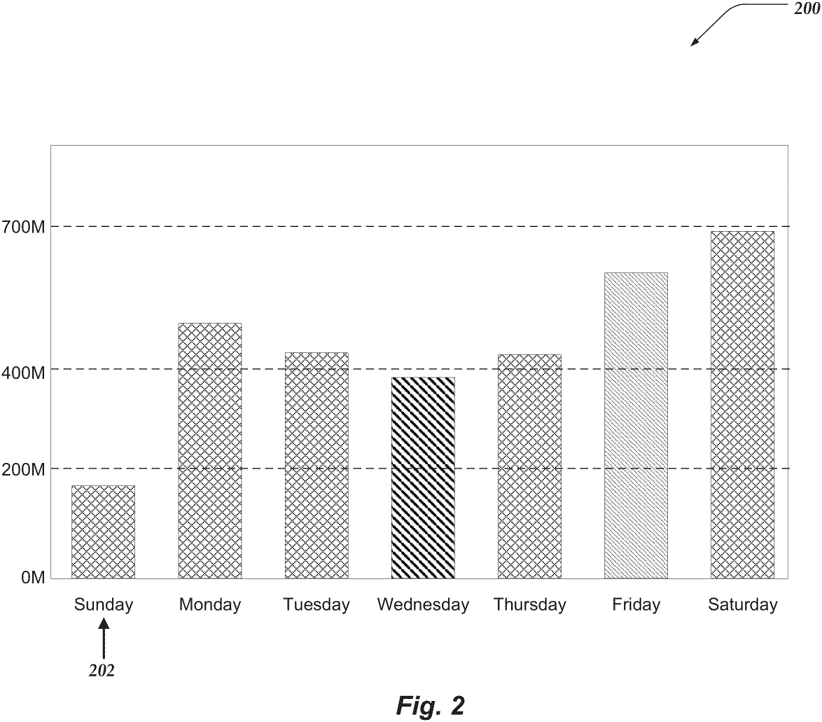

FIG. 2 illustrates a logical representation of a portion of visualization 200 in accordance with one or more of the various embodiments. As described above, visualization engines may be arranged to employ visualization models and data to generate visualizations, such as, visualization 200. In this example, visualization 200 represents a bar chart that shows sales revenue per day-of-week. One of ordinary skill in the art will appreciate that visualization models or visualization engines may be arranged to generate many different types of visualizations for various purposes depending on the design goals of users or organizations. Here, visualization 200 is presented as a non-limiting example to help provide clarity to the description of these innovations. One of ordinary skill in the art will appreciate that this example is at least sufficient to disclose the innovations herein and that visualization engines or visualization models may be arranged to generate many different visualizations for many different purposes in many domains.

In this example, visualization 200 includes mark 202 that represents the revenue earned on Sunday. Accordingly, in this example, mark 202 may appear to be an anomalous result given that it appears to be significantly lower than the other marks in visualization 200.

In this example, mark 202 may be determined to be a mark of interest because it may appear to anomalous compared to the other marks that may be associated with the revenue values for the other days-of-the-week. In some embodiments, users may be enabled to identify one or more marks-of-interest that seem interesting or anomalous. Also, in some embodiments, an evaluation engine may be arranged to automatically identify one or more marks-of-interest based on automatically identifying marks that may be anomalies or statistical outliers.

In some embodiments, if a mark may be identified as a mark-of-interest, an evaluation engine may be arranged to automatically perform one or more actions to analyze the mark-of-interest to provide an explanation for the apparent discrepancies. In some cases, an analysis performed by the evaluation engine may determine that the mark-of-interest may be within expectations rather than being an anomaly.

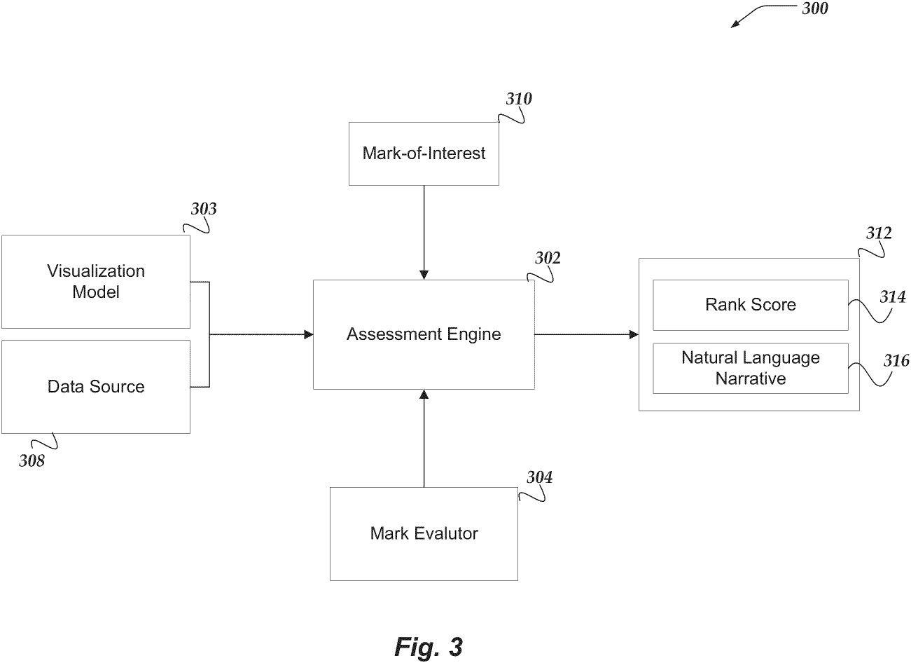

FIG. 3 illustrates a logical representation of a portion of mark evaluation system 300 in accordance with one or more of the various embodiments. In one or more of the various embodiments, system 300 may include one or more components, such as, evaluation engine 302, mark evaluator 304, visualization model 306, data source 308, mark-of-interest 310, evaluation result 312. In some embodiments, evaluation results, such as, evaluation result 312 may be arranged to include confidence score 314 or narrative 316.

In one or more of the various embodiments, evaluation engine 302 may be arranged to assess mark-of-interest 310 based on mark evaluator 304. In one or more of the various embodiments, mark evaluators may be arranged to include one or more heuristics or machine-learning evaluators that may be executed to classify marks-of-interest.

As discussed herein, evaluation engines may be arranged to employ one or more mark evaluators and provide one or more reports regarding how well a given mark evaluator matches (or classifies) a mark-of-interest. Accordingly, in this example, evaluation result 312 includes a score, such as, confidence score 314 and natural language narrative 316.

In one or more of the various embodiments, mark evaluators may be arranged to provide a score that represents how well they explain the marks-of-interest. In some embodiments, evaluation engines may be arranged to execute or apply mark evaluators to perform various evaluations of the mark-of-interests, visualization models, or data sources to classify the mark-of-interest. In some embodiments, confidence scores that represent how well the mark-of-interest fits the mark evaluator may be provided by the mark evaluator. For example, mark evaluator A may be arranged to execute ten tests or evaluate ten conditions that provide a score that includes ten points for each matched condition. Likewise, in some embodiments, mark evaluators may execute or apply one classifier that provides a confidence score.

In one or more of the various embodiments, mark evaluators may be arranged to provide natural language narratives, such as, narrative 316. In some embodiments, natural language narratives may be employed in user interfaces or reports that may be provided to a user to explain the evaluation of the marks-of-interest. In some embodiments, narratives may be based on templates that enable labels, units, values, or the like, that may be associated with mark-of-interest or visualization model to be included in the user interfaces or report information.

In one or more of the various embodiments, mark evaluators may be designed or tailored to evaluate one or more statistical features of data associated with a mark-of-interest. Accordingly, in one or more of the various embodiments, evaluation engines may be arranged to apply one or more mark evaluators to assess if the data associated with a mark-of-interest have the one or more of the statistical features targeted by a mark evaluator. In some embodiments, mark evaluators may be arranged to provide the confidence score as a form of a self-grade that represents how close the data associated with the mark-of-interest matches the statistical features the mark evaluator may be designed to match or otherwise evaluate.

In one or more of the various embodiments, one or more mark evaluators may focus on general, well-known, or commonplace statistical features that may be expected to be associated with marks-of-interest. Also, in one or more of the various embodiments, one or more mark evaluators may be customized or directed to particular problem domains or business domains. For example, mark evaluators directed to financial information may be arranged differently than mark evaluators directed to employee information. Likewise, for example, mark evaluators directed to the automobile industry may be arranged differently than mark evaluators directed to the cruise (ship) industry. Further, in one or more of the various embodiments, one or more mark evaluators may be customized for particular data sources or visualization models for a particular organization or user. Accordingly, in one or more of the various embodiments, mark evaluators may be stored in data store that enables them to be configured independently from each other.

In one or more of the various embodiments, evaluation engines may be arranged to generate or maintain profiles for one or more mark evaluators. In some embodiments, profiles may be arranged to track information that may be used for adapting mark evaluator results to particular organizations, users, problem domains, or the like. Accordingly, in one or more of the various embodiments, evaluation engines may be arranged to employ user activity information or user feedback to automatically build mark evaluator profiles that may be employed to modify or customize evaluation reports. For example, if users of an organization consistently report mismatches between the marks-of-interest and evaluation results, the evaluation engine may be arranged to introduce weighting rules that increase or decrease the effective confidence scores used for ranking evaluation results for the organization based on the user feedback information.

In one or more of the various embodiments, if a user selects a mark-of-interest in a visualization, the evaluation engine may determine one or more mark evaluators and apply them to the mark-of-interest and its associated visualization model or data source. Accordingly, non-limiting examples of mark evaluators are discussed below. For brevity and clarity this discussion is limited to a few examples, however, one of ordinary skill in the art will appreciate that other mark evaluators that may incorporate other or additional evaluation strategies are contemplated.

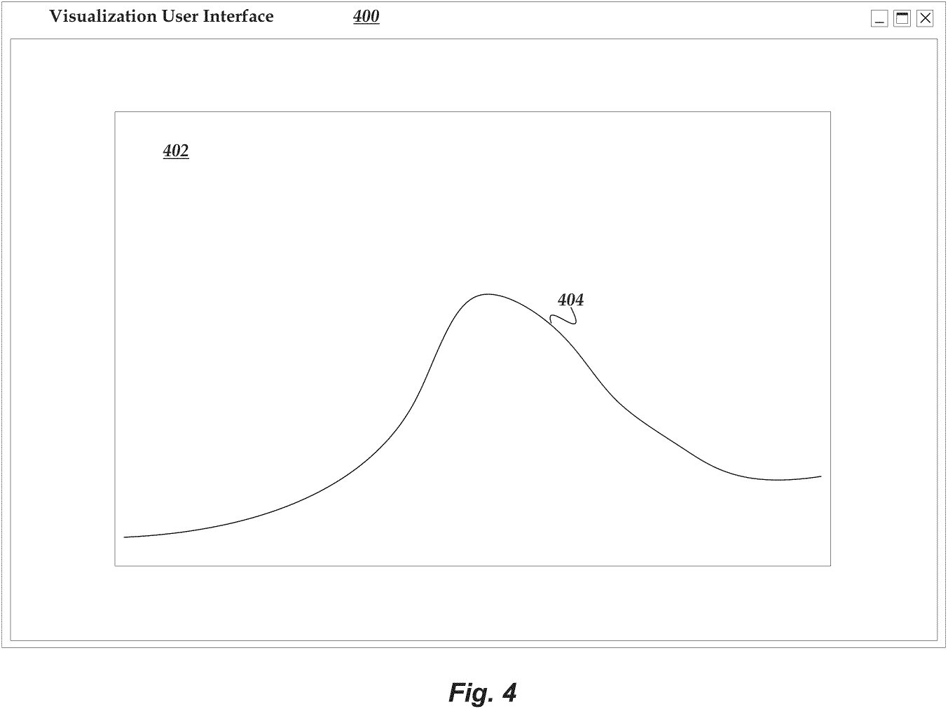

FIG. 4 illustrates a logical representation of user interface 400 for viewing or interacting with visualizations in accordance with one or more of the various embodiments. In this example, user interface 400 is represented as displaying visualization 402. In this example, curve 404 represents a visualization of one or more values included in visualization 402. As mentioned above, visualization platforms may provide one or more user interface that enable visualization authors to design visualization models that a visualization engine may render into visualizations, such as, visualization 402.

Accordingly, in some embodiments, visualization platform may enable visualization users to view or interact with the authored visualizations as enabled by the visualization authors. Generally, visualization authors may provide visualizations that are designed to be sufficient for enabling users to improve their understanding of the data or concepts represented by the visualization.

However, as mentioned above, in some cases, users of visualizations may have questions regarding why a mark in a visualization appears the ways it does in the visualization. In some cases, visualization authors may design visualizations that explicitly provide an explanation of the marks for users. However, in some embodiments, in some cases, users may have questions that are not anticipated by visualization authors. Also, in some cases, the underlying data may have changed since the visualization was originally designed. Thus, in some cases, data changes may invite questions about the data or the marks in the visualizations that visualization authors may not have anticipated.

Accordingly, in some embodiments, visualization platforms may be arranged to provide evaluation engines that enable visualization users to explore or discover data-based explanations regarding the reasons for how one or more marks may appear in the visualizations.

Note, in some embodiments, visualization platforms may provide evaluation engine tools to visualization authors that may be similar to evaluation tools provided to non-authoring users that may be used while creating visualizations. Thus, in some embodiments, visualization authors may be enabled to evaluate the appearance of one or more marks as they are authoring the visualizations.

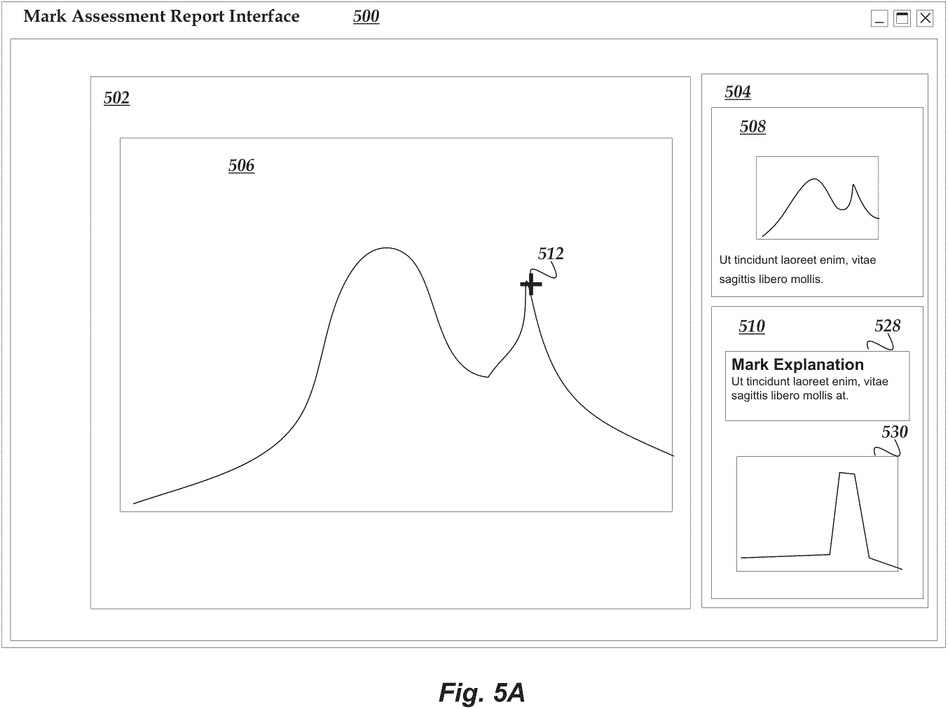

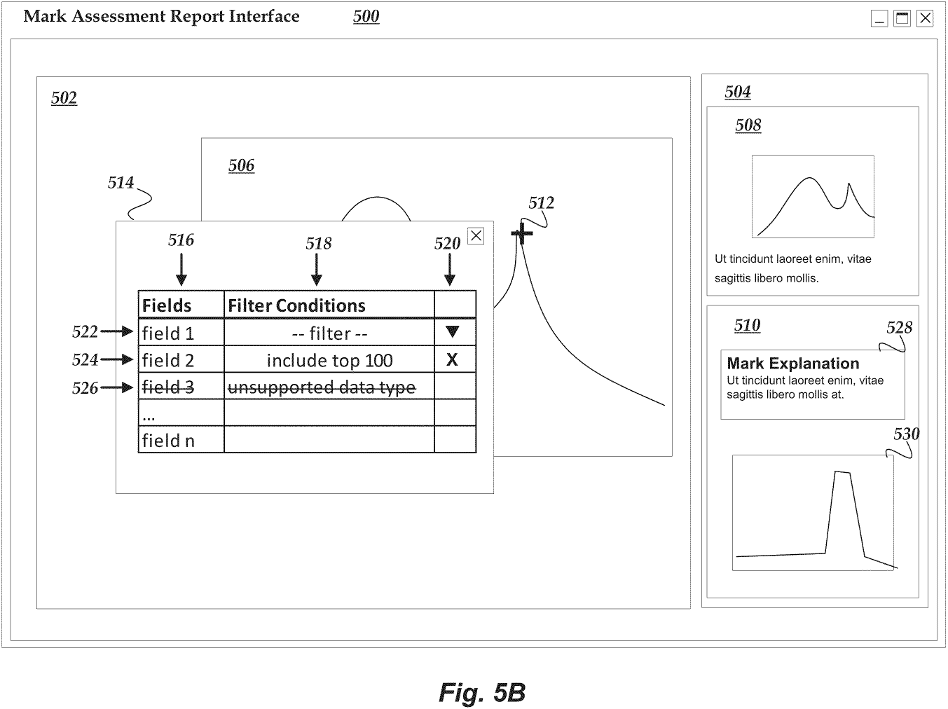

FIG. 5A illustrates a logical representation of user interface 500 for user interfaces for analyzing data based on visualization features in accordance with one or more of the various embodiments. In this example, a visualization platform may be arranged to provide one or more user interfaces performing mark evaluation operations, such as, user interface 500. In some embodiments, mark evaluation user interfaces may include: one or more display panels, such as, display panel 502; one or more evaluation panels, such as, evaluation panel 504; or the like. In this example, for some embodiments, display panel 502 may be arranged to display visualization 506. Also, in some embodiments, display panel 504 may be arranged to display one or more views associated with user interfaces for analyzing data based on visualization features, such as, evaluation overview view 508, mark explanation view 510, or the like. Note, one of ordinary skill in the art will appreciate that the number of display panels, evaluation views, or the like, may vary depending on the design of a given visualization. For example, in some embodiments, visualization authors may be enabled to include more than one visualization (sub-visualizations) in an authored visualization. Likewise, in one or more of the various embodiments, the arrangement, styling, or positioning of display panels, visualizations, evaluation views, or the like, may vary depending on the particular design of a visualization or as result of one or more interactions of users.

As mentioned above, users may be enabled to select one or more marks in visualizations for evaluation. In this example, mark 512 represents a mark-of-interest determined for evaluation. Accordingly, in some embodiments, an evaluation engine may be arranged to employ mark evaluators that may determine one or more evaluation results associated with the explanations for the appearance or value of the selected mark-of-interest. In this example, evaluation view 508 represents a view that displays summary information associated with visualization 506 or mark 512. Also, in this example, evaluation view 510 may display information that may explain the appearance or value of mark 512. Note, while these examples include supporting explanation visualizations in the evaluation views, one of ordinary skill in the art will appreciate that in some embodiments or some cases, some or all explanation visualizations may be omitted.

Also, one of ordinary skill in the art will appreciate that in production environments (as described above) there may be different types of explanations for various marks-of-interest that may depend on the underlying data or the design of the visualization. Accordingly, one of ordinary skill in the art will appreciate that for brevity and clarity placeholder evaluation views have been used here to illustrate a non-limiting example.

In one or more of the various embodiments, evaluation views may be comprised of explanation visualizations, explanation narratives (textual descriptions), or the like. Also, in some embodiments, evaluation views may be interactive such that they may support viewing or selecting alternative explanations, different views for the same explanations, or the like. Also, in some embodiments, the particular styling, placement, availability, or the like, of evaluation views may vary depending on the visualization design, underlying data, local requirements, local circumstances, or the like. Thus, in some embodiments, evaluation engines may be arranged to employ rules, templates, style sheets, or the like, provided via configuration information to determine some or all of the particular styling, placement, evaluation-type availability, or the like, of evaluation views.

In one or more of the various embodiments, evaluation engines may be arranged to categorize explanations into one or more categories such that each category may be displayed in separate sections of evaluation panel 504. In some embodiments, evaluation engines may be arranged to categorize explanations into those explanations that may be associated with or determined from the values of the mark-of-interest and those explanations that may be associated with or determined from the other values in the visualization.

In one or more of the various embodiments, evaluation engines may be arranged to display one or more explanation narratives, such as, explanation narrative 528 that include text-based descriptions that may correspond to particular explanations of one or more characteristics of a mark-of-interest. In some embodiments, if an explanation narrative may be selected, evaluation engines may be arranged to display further explanation narratives that provide additional details regarding a particular explanation, including a list or display of one or more characteristics of the mark-of-interest that may be determined by the one or more mark evaluators. Accordingly, in some embodiments, a user may easily determine an interest level in the explanation before drilling down into more detail about a particular explanation.

Also, in one or more of the various embodiments, evaluation engines may be arranged to display one or more explanation visualizations, such as, explanation visualization 530 that may be separate from visualization 506. In some embodiments explanation visualizations may correspond to particular explanations of one or more characteristics of a mark-of-interest. In some embodiments, if an explanation visualization may be selected, evaluation engines may be arranged to display additional explanation visualizations that provide additional details regarding a particular explanation or evaluation result, including interactive explanation visualizations that enable users to filter, expand, or view one or more marks, values, or fields from visualization 506 (or from related visualizations), or view, filter, expand values or records from the underlying data sources that may be associated with the mark-of-interest. Accordingly, in some embodiments, a user may easily determine an interest level in the explanation from the top-level explanation visualization before drilling down into more detail about a particular explanation.

FIG. 5B illustrates a logical representation of user interface 500 for user interfaces for analyzing data based on visualization features in accordance with one or more of the various embodiments. Accordingly, as described above, system 500 includes display panel 502, evaluation panel 504, visualization 506, evaluation overview view 508, mark explanation view 510, explanation narrative 528, explanation visualization 530, or the like.

In some embodiments, evaluation engines may be arranged to enable visualization authors to configure one or more evaluation features that may be made available to users. In some embodiments, evaluation engines may be arranged to provide one or more user interfaces such as user interface 514 that may enable visualization authors to configure some or all evaluation features. Accordingly, in this example, user interface 514 represents a user interface that enables visualization authors to set various filters for various data fields that may be associated with a visualization. In this example, column 516 shows data field names, column 518 shows a type of filter that may be applied during evaluation operations, column 520 represents one or more user interface controls that may be employed for viewing or selecting filters or filter conditions.

Accordingly, in this example, row 522 represents a data field (field 1) that has not been associated with a filter. Thus, in some embodiments, all for the values associated with the field may be available for assessing marks. Also, in this example, row 524 represents a data field (field 2) that has been associated with a filter. Thus, in this example, the top 100 values for field 2 may be available for assessing marks. Also, in some cases, for some embodiments, one or more fields representing particular data types may be excluded from mark evaluation. In this example, row 526 represents a data field that has been excluded from mark evaluation because its datatype may be unsupported. One of ordinary skill in the art will appreciate that evaluation engines may be arranged to provide more or fewer filters, conditions, or the like, than shown here. For brevity and clarity, exhaustive description of the various filter, conditions, or the like, is omitted. However, in some embodiments, evaluation engines may be arranged to employ rules, instructions, templates, filter, conditions, or the like, provided via configuration information to account for local requirements or local circumstances. For example, in some embodiments, additional filters or conditions may be included if they may be determined to be useful or relevant to user interfaces for analyzing data based on visualization features. Also, in some cases, evaluation engines may be configured to omit one or more filter, conditions, or the like in response to local requirements or local circumstances, such as, operator preferences, or the like.

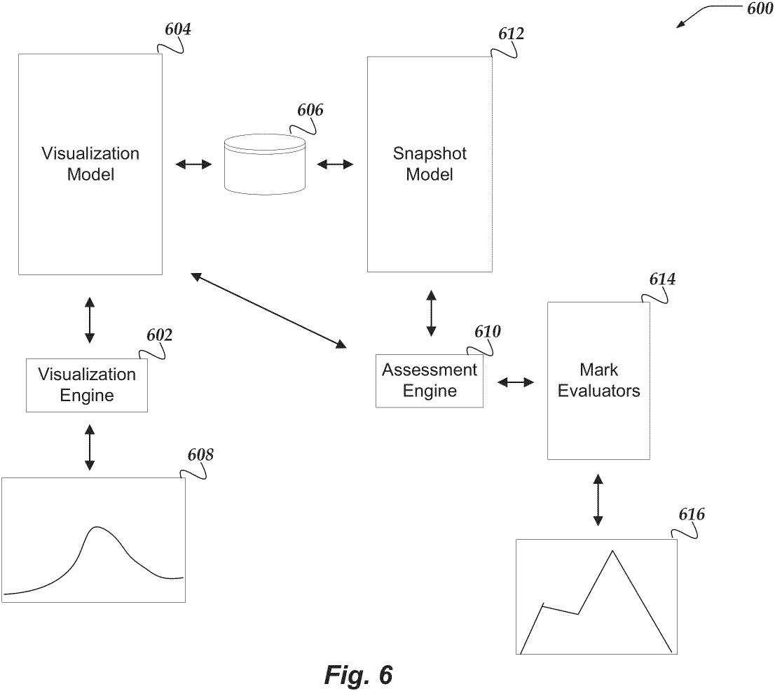

FIG. 6 illustrates a logical schematic of a portion of system 600 for user interfaces for analyzing data based on visualization features in accordance with one or more of the various embodiments. In one or more of the various embodiments, evaluation engines may be arranged to provide mark evaluations on demand based on user input. For example, for some embodiments, users may be enabled to select one or more marks in a visualization to initiate an evaluation of the selected marks (e.g., marks-of-interest).

As described above, in one or more of the various embodiments, visualization engine 602 may be arranged to employ visualization model 604, data source 606, or the like, to generate visualization 608. In some embodiments, visualization engine 602 may be arranged to generate visualization 608 based on combining the display objects in visualization model 604 with data/information provided from data source 606.

In some embodiments, if there may be changes to the data in data source 606, the appearance of visualization 608 may change as well. In some embodiments, for some cases, visualizations may be configured to be associated with dynamic data fields that may change values. Likewise, in some embodiments, one or more visualizations may be designed (by visualization authors) to enable users to interactively change one or more values represented in visualizations. For example, in some embodiments, a visualization may be designed to include a user interface control, such as a slider control that enables users to change a field value within a designated range. Similarly, for example, a visualization may be designed to enable users to perform other manipulations of visualizations, such as: adding or removing one or more specific fields; modifying the scope or scale of the values; activating/deactivating one or more formulas; or the like.

Accordingly, in some embodiments, evaluation engines, such as, evaluation engine 610 may be arranged to generate snapshot models, such as, snapshot model 612 that capture and represent the current state of visualization model 604, values from data source 606, the appearance of visualization 608, or the like. Thus, in some embodiments, evaluation engines may be arranged to provide a consistent view of visualization environment. Otherwise, in some cases, changes to the underlying data may disrupt pending mark evaluations.

In one or more of the various embodiments, evaluation engines may be arranged to generate snapshot models that capture the appearance of the visualizations being evaluated. Also, in some embodiments, evaluation engines may be arranged to capture some or all of the underlying data to preserve those values during mark evaluation.

In one or more of the various embodiments, evaluation engines may be arranged to monitor changes made to visualizations, data sources, data values, or the like, to detect if the snapshot model is out of date. Accordingly, in some embodiments, evaluation engines may be arranged to provide one or more notification, alarm, indicator, or the like, that may inform users that the underlying visualization or data sources have changed since the snapshot model was generated. In some embodiments, evaluation engines may provide one or more user interfaces that enable users to continue their evaluation using the current snapshot models or update or refresh the snapshot model to reflect to current state of the visualization or its underlying data.

In one or more of the various embodiments, evaluation engines may be arranged to employ one or more mark evaluators, such as, mark evaluator 614 to assess the marks-of-interest based on snapshot model 612.

In one or more of the various embodiments, evaluation engines may be arranged to generate one or more mark explanation visualizations, such as, mark explanation view 616 that may help explain to visualization users or visualization authors the appearance of the one or more marks-of-interest.

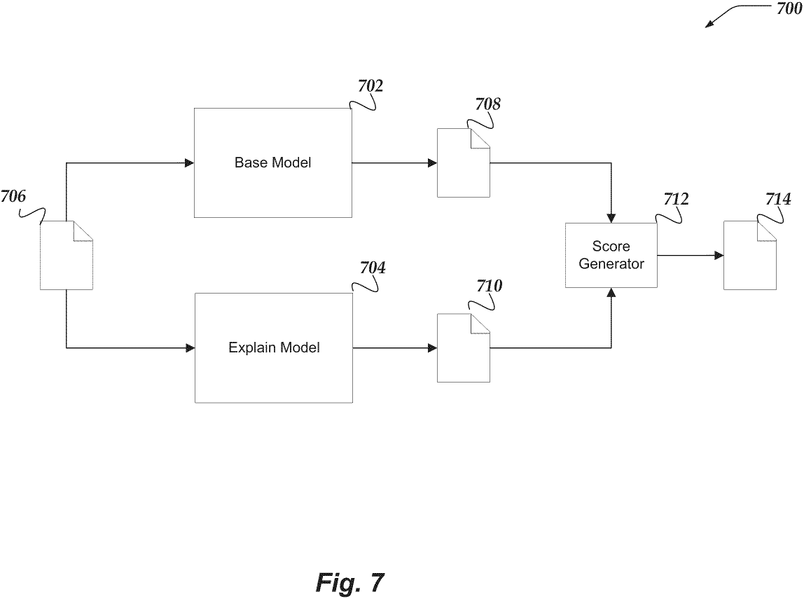

FIG. 7 illustrates a logical schematic of mark evaluator 700 for user interfaces for analyzing data based on visualization features in accordance with one or more of the various embodiments. As described above, evaluation engines may be arranged to employ one or more mark evaluators to determine an explanation regarding to the appearance or value for one or more marks (marks-of-interest) that may be in a visualization.

In one or more of the various embodiments, mark evaluators may include one or more sub-model. In some embodiments, mark evaluators may be arranged to include a base model, such as, base model 702 and am explanation model, such as, explanation model 704. Accordingly, in some embodiments, data associated with the visualization being evaluated, such as, source data 706 may be provided to a base model, such as, base model 702 and an explanation model, such as, explanation model 704.

In one or more of the various embodiments, evaluation engines may be arranged to fit the source data to each of the base model and explanation model. In some embodiments, evaluation engines may be arranged to determine an error score for each of the base model (e.g., error score 708) and the explanation model (e.g., error score 710).

In one or more of the various embodiments, the error scores may be provided to a score generator, such as, score generator 712. Accordingly, in some embodiments, score generators, such as, score generator 712 may be arranged to generate an overall score, such as, overall score 714 based on the scores provided by the base model and the explanation model.

Thus, in some embodiments, if the overall score exceeds a threshold value, the explanation corresponding to the mark evaluator may be provided as an explanation of the mark.

### Generalized Operations

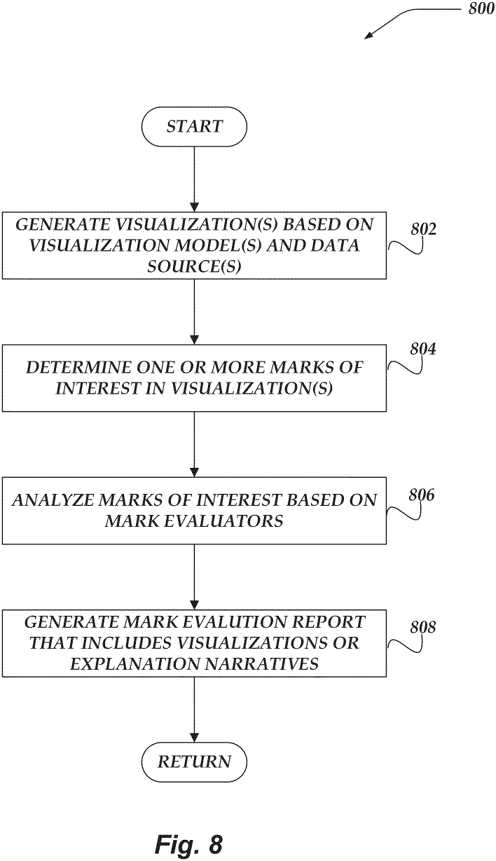

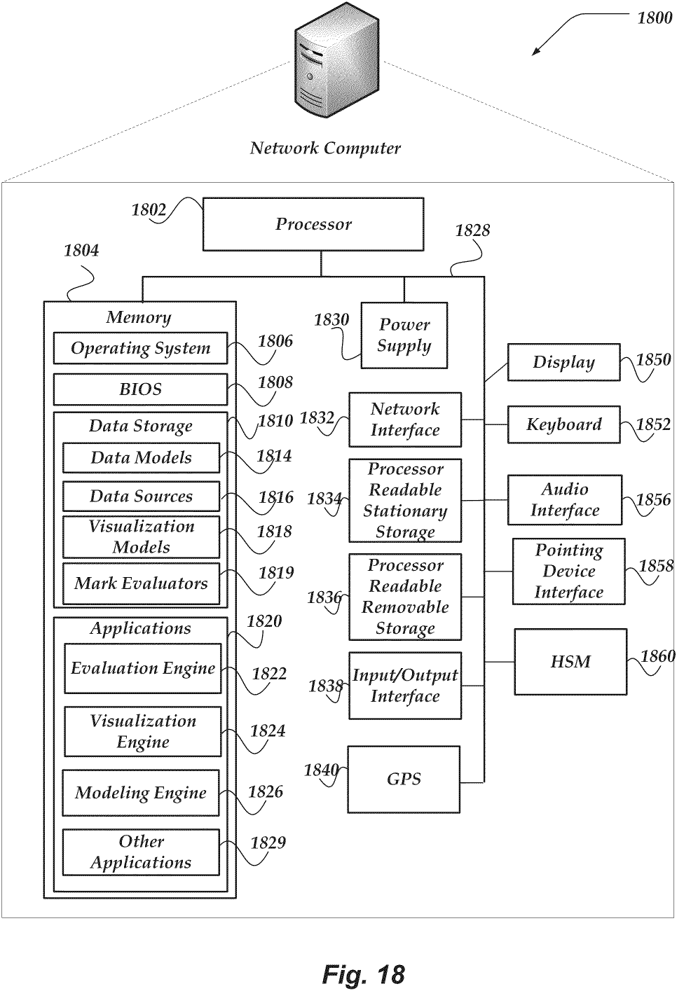

FIGS. 8-15 represent generalized operations for user interfaces for analyzing data based on visualization features for data objects in accordance with one or more of the various embodiments. In one or more of the various embodiments, processes 800, 900, 1000, 1100, 1200, 1300, 1400, and 1500 described in conjunction with FIGS. 1-7 and FIGS. 16-18 may be implemented by or executed by one or more processors on a single network computer, such as network computer 1800 of FIG. 18. In other embodiments, these processes, or portions thereof, may be implemented by or executed on a plurality of network computers, such as network computer 1800 of FIG. 18. In yet other embodiments, these processes, or portions thereof, may be implemented by or executed on one or more virtualized computers, such as, those in a cloud-based environment. However, embodiments are not so limited and various combinations of network computers, client computers, or the like may be utilized. Further, in one or more of the various embodiments, the processes described in conjunction with FIGS. 8-15 may be used for user interfaces for analyzing data based on visualization features in accordance with at least one of the various embodiments or architectures such as those described in conjunction with FIGS. 1-7. Further, in one or more of the various embodiments, some or all of the actions performed by processes 800, 900, 1000, 1100, 1200, 1300, 1400, and 1500 may be executed in part by evaluation engine 1822, visualization engine 1824, or modeling engine 1826 running on one or more processors of one or more network computers.

FIG. 8 illustrates an overview flowchart of process 800 for user interfaces for analyzing data based on visualization features in accordance with one or more of the various embodiments. After a start block, at block 802, in one or more of the various embodiments, a visualization platform may generate one or more visualizations based on one or more visualization models and one or more data sources. As described above, visualization platforms may be arranged to enable visualization authors to interactively create one or more visualizations based on data from one or more data sources. Likewise, in some embodiments, visualization platforms may be arranged to enable visualization authors to publish or otherwise make their authored visualizations available to users that may be enabled to interact with the published visualizations. Note, users may be enabled to interact with visualizations to the extent enabled by the authors of the visualization.

At block 804, in one or more of the various embodiments, one or more marks-of-interest in the visualizations may be determined. In one or more of the various embodiments, visualization authors may be enabled to select a mark-of-interest while they may be authoring visualizations. Likewise, in some embodiments, visualization users may be enabled to select a mark-of-interest in one or more published visualizations. Note, in some embodiments, as described above, the mark-of-interest enable for user interfaces for analyzing data based on visualization features may be restricted by visualization authors such that visualization users may be restricted from selecting one or more marks by the author that created or published the visualization.

Also, in one or more of the various embodiments, visualization platforms may be arranged to restrict one or more marks from analyzing data based on visualization features depending on the data type of the mark or its underlying data. For example, in some embodiments, one or more data types, such as, calendar dates may be restricted from analyzing data based on visualization features. However, in some embodiments, these types of restrictions may vary depending on the configuration of the evaluation engines. Accordingly, in some embodiments, evaluation engines may be arranged to employ rules, libraries, instructions, or the like, provided via configuration information to determine if particular data types may be excluded from analyzing data based on visualization features.

At block 806, in one or more of the various embodiments, evaluation engines may be arranged to analyze the marks-of-interest based on one or more mark evaluators. In one or more of the various embodiments, evaluation engines may be arranged to analyze the selected mark-of-interest to determine if there may be one or more reasons that may explain the values of the mark-of interest.

At block 808, in one or more of the various embodiments, evaluation engines may be arranged to generate one or more mark evaluation reports that include one or more explanation visualizations or one or more explanation narratives. In one or more of the various embodiments, mark evaluation reports may be considered to one or more interactive reports, user interfaces, text narratives, visualizations, or the like, that may be directed to inform users or authors of one or more possible explanations for the appearance/value of the mark-of-interest.

In one or more of the various embodiments, interactive reports may include summaries/lists that enable users to drill-down into detailed explanations. Also, in some embodiments, evaluation engines may be arranged to report that there may be no relevant explanations for a mark-of-interest. In some cases, an absence of explanations may be because scores determined for the one or more evaluators did not exceed a minimum confidence score, or the like.

Next, in one or more of the various embodiments, control may be returned to a calling process.

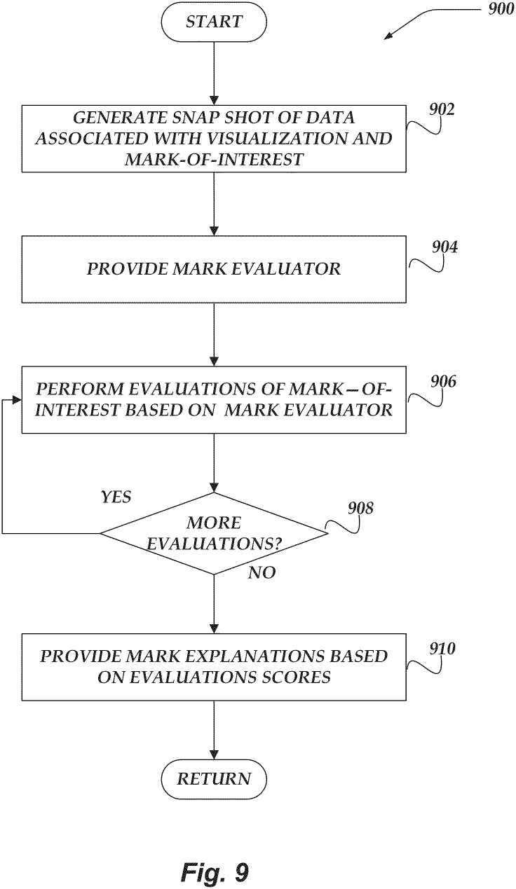

FIG. 9 illustrates a flowchart of process 900 for analyzing data based on visualization features in accordance with one or more of the various embodiments. After a start block, at block 902, in one or more of the various embodiments, evaluation engines may be arranged to provide a snapshot of data that may be associated with the visualization and a mark-of-interest.

In one or more of the various embodiments, visualization engines may be arranged to support visualizations that may update in real-time based on changes to the data underlying the visualizations. Accordingly, in some embodiments, if a mark-of-interest may be selected for evaluations, evaluation engines may be arranged to generate a data snapshot that preserves the state of the data for the visualization and mark being analyzed. Accordingly, in some embodiments, users may be provided a stable data environment during while analyzing data based on visualization features.

Similarly, in some embodiments, data snapshots enable users to navigate to other marks or other visualizations without automatically interrupting analyzing data based on visualization features. For example, in some embodiments, a user may be enabled to review another visualization or visualization view while the user interfaces for analyzing data based on visualization features remain consistent.

Note, in some embodiments, evaluation engines may be arranged to provide one or more user interface controls that enables users to discard a snapshot of data and collect another snapshot based on the currently selected mark-of-interest. Accordingly, in some embodiments, users may be enabled to determine if the mark-of-interest analysis should be updated to reflect the current state of the underlying data or the currently selected mark-of-interest or visualizations.

At block 904, in one or more of the various embodiments, evaluation engines may be arranged to provide one or more mark evaluators. As described above, in some embodiments, mark evaluators (e.g., evaluators) may be data structures the include or reference one or more models, heuristics, rules, or the like, that may determine how a mark-of-interest may be analyzed. In one or more of the various embodiments, one or more types of analysis may be included in the same evaluators. However, for brevity and clarity it may be assumed that each separate analysis may be associated with its own evaluator.

In some embodiments, evaluation engines may be arranged to enable organizations or authors enable or provide one or more various evaluators. In some embodiments, the availability of a particular evaluator may depend on the type of visualization, user permissions/access, subject matter domain of the visualization, customized requirements of customers or organizations, licensing, or the like. Accordingly, in one or more of the various embodiments, evaluation engines may be arranged to determine the available evaluators based on configuration information to account for local requirements or local circumstances.

At block 906, in one or more of the various embodiments, evaluation engines may be arranged to perform one or more evaluations of the mark-of-interest based on the mark evaluator and the snapshot data. In one or more of the various embodiments, evaluation engines may be arranged to execute the one or more evaluators to analyze the mark-of-interest. In one or more of the various embodiments, one or more evaluators may be disqualified based on the data type or other restrictions. In some embodiments, evaluation engines may be arranged to enable visualization authors to restrict the types of evaluations that may be performed for a particular visualization. Also, in some embodiments, evaluation engines may be arranged to enable organizations to provide or select one or more customized evaluators.

Accordingly, in some embodiments, if there may be one or more eligible evaluators, evaluation engines may be arranged to evaluate the mark-of-interest using those evaluators to analyze the mark-of-interest based on its values or visualization features.

At decision block 908, in one or more of the various embodiments, if there may be more evaluations, control may loop to block 906; otherwise, control may flow to block 910. Note, in some embodiments, two or more evaluations using different evaluators may be executed at the same time. As described above, in some embodiments, evaluation engines may be arranged to execute the one or more evaluators to determine evaluation scores that may indicate if a particular evaluator may provide a relevant explanation for a mark-of-interest.

At block 910, in one or more of the various embodiments, evaluation engines may be arranged to provide explanations of the mark-of-interest based on the evaluation scores that exceed a defined threshold value. In one or more of the various embodiments, evaluation engines may be arranged to employ templates, or the like, to provide narratives that describe the reasoning that supports the provided explanations. In some embodiments, specific narratives or narrative template may be associated with particular evaluators. Thus, in some embodiments, evaluation engines may be arranged to determine the narratives to provide based on determining the evaluators that produce predictions that are scored above a threshold score value. In some embodiments, specific field names, mark labels, visualization labels, or the like, may be inserted into narrative templates to provide explanation information.

Next, in one or more of the various embodiments, control may be returned to a calling process.

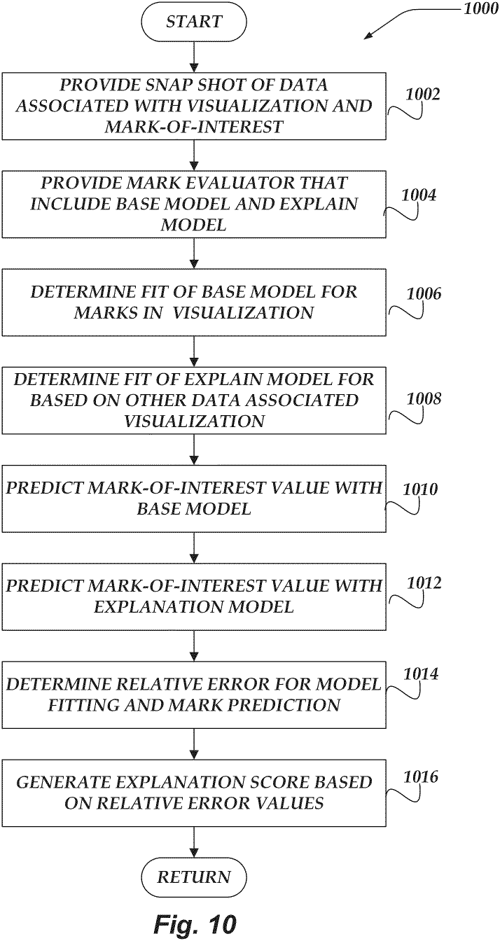

FIG. 10 illustrates a flowchart of process 1000 for analyzing data based on visualization features in accordance with one or more of the various embodiments. After a start block, at block 1002, in one or more of the various embodiments, evaluation engines may be arranged to provide a snapshot of data that may be associated with the visualization and a mark-of-interest. As described herein, evaluation engines may be arranged to generate a data snapshot that preserves the data associated with the mark-of-interest at the time it may have been selected from evaluation.

At block 1004, in one or more of the various embodiments, evaluation engines may be arranged to determine a mark evaluator that includes a base model and an explanation model. In some embodiments, base models may be analytical models that may be directed to evaluate the visualization based on data limited to the visualization being analyzed. In some embodiments, explanation models may be directed to evaluate the visualization using data associated with the visualization but not limited to the values of marks in the visualization.

As described above, in some embodiments, visualization platforms may be arranged to provide evaluators for testing the relevancy of more than one type of explanation. Accordingly, in some embodiments, evaluation engines may be arranged to adapt to various circumstances or requirements by including new or different evaluators that may be directed to new or different explanation types. Likewise, in some embodiments, evaluation engines may be arranged to update or exclude one or more evaluators from being used depending on various factors, such as, evaluator efficacy, user/organization preferences, licensing considerations, or the like. For example, in some cases, for various reasons, an evaluator that may be showing evidence of diminishing efficacy may be discarded, updated, or replaced to adapt the visualization platform to changed circumstances, changed preferences, or the like. Accordingly, in some embodiments, evaluation engines may be arranged to employ rules, libraries, instructions, or the like, for providing evaluators that may be provided via configuration information to account for local circumstances or local requirements.

At block 1006, in one or more of the various embodiments, evaluation engines may be arranged to determine the fit of the base model to the marks in the visualization. In one or more of the various embodiments, base models may be directed to determining how well the visualization data fits an expected shape, curve, other criteria, or the like. In some embodiments, base model may be configured to make predictions or otherwise fit curves to visualization data absent the mark-of-interest. Accordingly, in some embodiments, a base model may be arranged to test if the values in the visualization conform to an expected distribution of values absent the mark-of-interest. For example, a base model may be configured predict the average number of events (e.g., sales events) for marks in visualization.

Accordingly, in some embodiments, if the predictions of a base model match the marks in the visualization absent the mark-of-interest, evaluator model may measure how well the mark-of-interest conforms to the prediction.

At block 1008, in one or more of the various embodiments, evaluation engines may be arranged to determine the fit of the explanation model to the other marks associated with the visualization. In one or more of the various embodiments, explanation models may be configured to evaluate other data associated with the visualization beyond the values of its marks. In some embodiments, this may include data values that contribute to marks in the visualization. For example, in some cases, marks in the visualization may be aggregated or computed based on values from two or more different data fields that may not be explicitly displayed in the visualization. Accordingly, in some embodiments, explanation models may be configured to determine if one or more data values that contribute to the mark values in the visualization may contribute to an extreme or unique result. Likewise, for example, marks in the visualization may represent total sales per month but information such as customer, location of sale, day-of-week of sales, and so on, may not be included in the visualization even though they may contribute to why a mark-of-interest appears to be extreme or unique.

At block 1010, in one or more of the various embodiments, evaluation engines base model to employ the base model to predict the mark-of-interest value. In one or more of the various embodiments, the same base model that is used to fit to the visualization absent the mark-of-interest, may be employed to predict a value for the mark-of-interest.

At block 1012, in one or more of the various embodiments, evaluation engines base model to employ the explanation model to predict the mark-of-interest value. In one or more of the various embodiments, the same explanation model that is used to fit to the visualization absent the mark-of-interest, may be employed to predict a value for the mark-of-interest.

At block 1014, in one or more of the various embodiments, evaluation engines may be arranged to determine the relative error values for model fitting mark-of-interest prediction.

In one or more of the various embodiments, evaluation engines or evaluators may be arranged to determine a cumulative error score for the predictions made by the base model. For example, evaluation engines may be arranged to determine a partial base model fitting error score for a base model by determining the error of its prediction for each mark in the visualization (except for the mark-of-interest) where an error value may be determined by comparing a predicted value for a mark to the actual mark value. Similarly, in some embodiments, evaluation engines or evaluators may be arranged to determine a fitting error score for the explanation model.

Also, in some embodiments, a mark error score may be determined for the base model based on comparing the value the base model predicted for the mark-of-interest and the actual value of the mark-of-interest. Similarly, a mark error score may be determined for the explanation model based on comparing the value the explanation model predicted for the mark-of-interest and the actual value of the mark-of-interest.

In one or more of the various embodiments, one or more evaluator models may be configured to report/determine error values or score values. Accordingly, in some embodiments, evaluation engines may rely on the evaluator models to provide their own score values. Accordingly, in some embodiments, evaluation engines may remain enabled to determine error score values for each base model and explanation model even if a new form a base model or explanation model may be provided.

At block 1016, in one or more of the various embodiments, evaluation engines may be arranged to generate a score for the explanation based on the error score values. In one or more of the various embodiments, evaluation engines may be arranged to determine an overall score for a given explanation type based on the base model error scores and the explanation model error scores. For example, in some embodiments, evaluation engines may be arranged to compute relative fit scores based on a ratio of the explanation fit error score and the base model fit error score and relative mark scores based on a ratio of the explanation model mark prediction error score and the base model mark prediction error score, such as: relative_fit = explanation_fit_score / base_model_fit_score; relative_mark_score = explanation_model_mark_score / base_model_mark_score, or the like. Thus, if the relative fit score and the relative mark prediction score exceed a defined threshold value, the corresponding explanation may be considered relevant to the mark-of-interest.

In one or more of the various embodiments, evaluation engines may be arranged to enable scoring formulas to be adapted to different local circumstances or local requirements. In some embodiments, formulas may be adapted to new or different evaluator, base models, explanation models, or the like. In some cases, different or new explanations may be introduced to the visualization platform as they may be discovered or developed. Accordingly, in some embodiments, evaluation engines may be arranged to employ rules, libraries, instructions, or the like, for determining explanation scores that may be provided via configuration information to account for local circumstances or local requirements.

Next, in one or more of the various embodiments, control may be returned to a calling process.

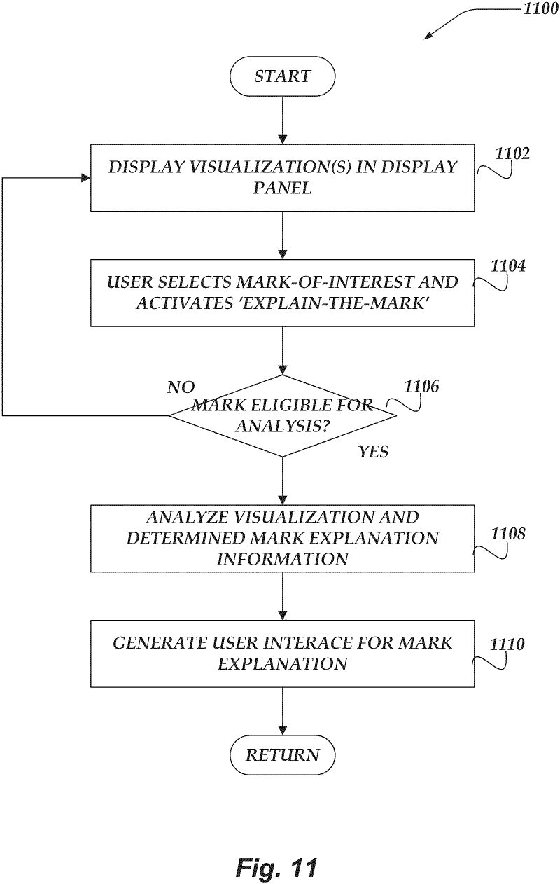

FIG. 11 illustrates an overview flowchart for process 1100 for user interfaces for analyzing data based on visualization features in accordance with one or more of the various embodiments. After a start block at 1102, in one or more of the various embodiments, visualization platform may display one or more visualizations in one or more display panels. As described about, visualization platforms may enable visualization authors to view visualization as they are created. Likewise, non-authoring users may be granted rights to access, view, or interact with visualizations as defined by the visualization author.

In some embodiments, visualization platforms may enable visualization authors access to ‘explain-the-mark’ features to analyze data or visualizations based on visualization features while they are authoring visualizations.

In some embodiments, visualization authors may enable one or more visualizations or one or more mark types to be eligible for ‘explain-the-mark’ features to analyze data or visualizations based on visualization features.

At block 1104, in one or more of the various embodiments, a visualization user or visualization author may select a mark-of-interest and enables/activates mark explanation. In some embodiments, if one or more visualizations includes marks that may be eligible for analyzing data based on visualization features, users may be enabled to select a mark for analysis.

At decision block 1106, in one or more of the various embodiments, if the selected mark-of-interest may be eligible for analysis, control may flow to block 1108; otherwise, control may loop back to block 1102. In some cases, one or more marks in a visualization may be ineligible for analysis for various reasons, including, ineligible data type, restrictions put in place by the visualization author, or the like. In some embodiments, visualization engines may be arranged to enable one or more user interface indicators, such as, tool-tips, or the like, to communicate that a mark may be eligible for analysis.

Accordingly, in some embodiments, if a selected mark is eligible for analysis, it may be deemed the mark-of-interest.

At block 1108, in one or more of the various embodiments, evaluation engines may be arranged to analyze the visualization associated with the mark-of-interest and determine an explanation for the mark or supporting information. As described above, evaluation engines may be arranged to employ one or more evaluators to analyze the mark-of-interest and determine if it matches one or more explanation types.

At block 1110, in one or more of the various embodiments, evaluation engines may be arranged to generate a user interface for providing an interactive report that provided an explanation of the mark-of-interest for the user.

In some embodiments, the visualization engine may enable the evaluation engine to provide a user interface display panel for explaining-the-mark to the user. In some embodiments, such user interfaces may include side-bar display panels, or dialog boxes for users. In some embodiments, side-bar displays may be advantageous because the analysis and explanation information may be display without obscuring the visualization that includes the mark-of-interest. As described herein, this user interface may include interactive reports, text narratives, lists of reasons, lists of relevant fields or data sources, or the like.

In some cases, for some embodiments, evaluation engines may determine that the mark-of-interest cannot be explained by the available evaluators. For example, if none of the evaluators result in scores above a threshold value, the evaluation engine may report that they may be ‘no explanation’ for the mark-of-interest.

In some embodiments, the mark explanation user interface may be available until a user expressly cancels or closes the user interface. Accordingly, in some embodiments, if a user navigates away from the visualization that corresponds to the mark-of-interest, the mark explanation user interfaces may remain visible or otherwise available. In some embodiments, if the user may be an author, one or more portions of the mark information user interface (e.g., explanation visualizations) may be created and added to the visualization platform workspace.

Next, in one or more of the various embodiments, control may be returned to a calling process.

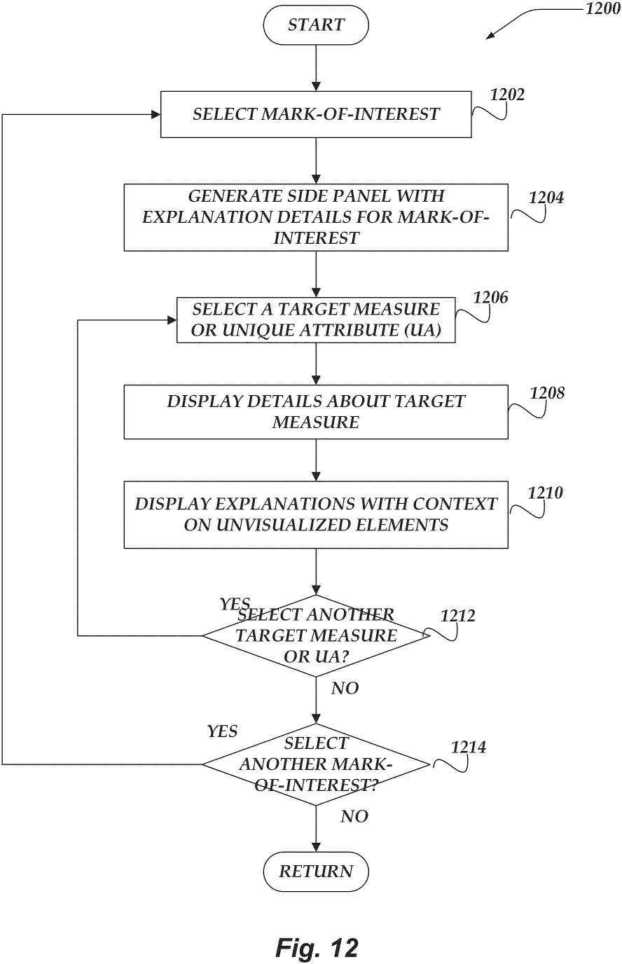

FIG. 12 illustrates a flowchart for process 1200 for user interfaces for analyzing data based on visualization features in accordance with one or more of the various embodiments. After a start block at 1202, in one or more of the various embodiments, as described above, visualization engines may be arranged to generate one or more interactive visualizations that enable a user (or visualization author) to select a mark-of-interest.

At block 1204, in one or more of the various embodiments, visualization engines may be arranged to generate a side-panel user interface for displaying one or more details about the mark-of-interest and a list of evaluation/analysis options. In one or more of the various embodiments, if the evaluation engine determines one or more explanations relevant to the mark-of-interest, they may be displayed in the explanation user interface. In some embodiments, if more than one type of explanation may be determined to be relevant, they may be grouped into sections in user interface. In some embodiments, explanation types may include target measurements that may be related to how the mark-of-interest value compares to other values for the same type of mark in the same visualization. For example, the mark-of-interest value may be significantly larger than its peer marks in the same visualization. Accordingly, in some embodiments, differences based on measuring the mark-of-interest against its peer marks may be considered target measurement explanations.

Also, in some embodiments, evaluation engines may be arranged to employ one or more evaluators that may determine if the mark-of-interest has one or more unique attributes that may contribute to the explanation for the mark value. For example, if the mark-of-interest represents total sales for a month, an example of a unique attribute may include that the sales for that month included an out-sized sale that cause the mark-of-interest appear different than its peer marks. Likewise, for example, a unique attribute could be that the sales for the mark-of-interest occurred in different/uncommon geographic regions as compared to its peer marks. Note, the evaluators that test for unique attributes may evaluate many different fields to determine if the data contributing to the mark-of-interest result may be extreme or unique for the mark-of-interest.

One of ordinary skill in the art will appreciate that the particular target measurements or unique attributes that may be tested or evaluated may vary depending on the available evaluators, data types, user/author preferences, or the like.

At block 1206, in one or more of the various embodiments, users may be enabled to select a target measure or unique attribute associated with the mark-of-interest. In one or more of the various embodiments, display space at the top level of the mark explanation user interface may be limited. Accordingly, in some embodiments, users may be enabled to drill-down to see more details about the specific target measure or unique attribute.

At block 1208, in one or more of the various embodiments, visualization engines may be arranged to display one or more details based on the values of the mark-of-interest and the target measure.

In one or more of the various embodiments, details may include independent visualizations that show how the value of the mark-of-interest compares to its peer marks, or the like. In some embodiments, for some embodiments, the independent visualizations may include interactive features the enable users to explore the explanation data independent from the visualization that included the mark-of-interest.

At block 1210, in one or more of the various embodiments, visualization engines may be arranged to display one or more explanations based on the values of one or more elements that may be omitted from the visualization. At decision block 1212, in one or more of the various embodiments, if the user selected another target measure or unique attribute, control may loop back to block 1206; otherwise, control may flow to decision block 1214. At decision block 1214, in one or more of the various embodiments, if the user selects another mark-of-interest, control may flow to block 1202; otherwise, control may be returned to a calling process.

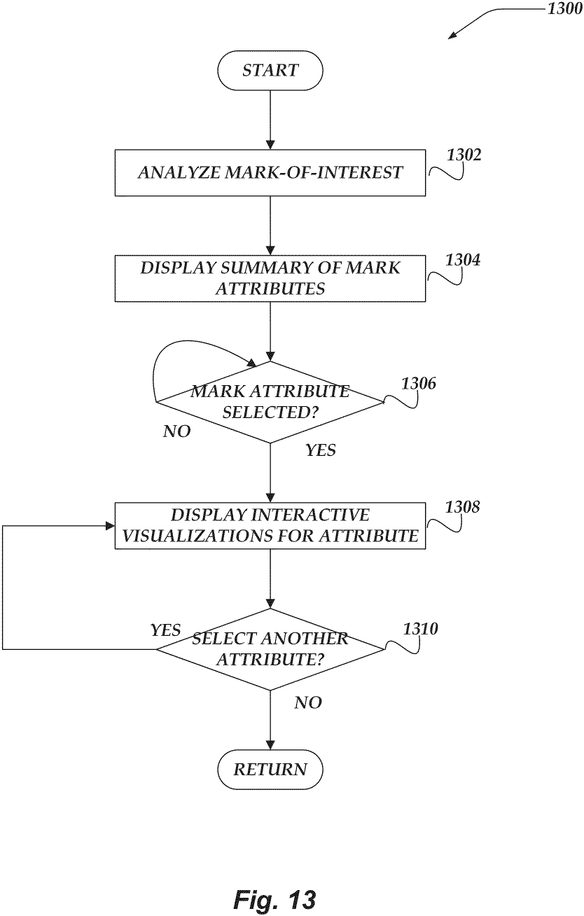

FIG. 13 illustrates a flowchart for process 1300 for user interfaces for analyzing data based on visualization features in accordance with one or more of the various embodiments. After a start block at 1302, in one or more of the various embodiments, evaluation engines may be arranged to analyze the mark-of-interest. At block 1304, in one or more of the various embodiments, evaluation engines may be arranged to display a summary of attributes associated with the mark-of-interest. At decision block 1306, in one or more of the various embodiments, if an attribute associated with the mark-of-interest is selected, control may flow to block 1308; otherwise, control may loop to decision block 1306. At block 1308, in one or more of the various embodiments, evaluation engines may be arranged to display one or more interactive visualizations for the selected attributes. At decision block 1310, in one or more of the various embodiments, if another attribute may be selected, control may flow to block 1308; otherwise, control may be returned to a calling process.

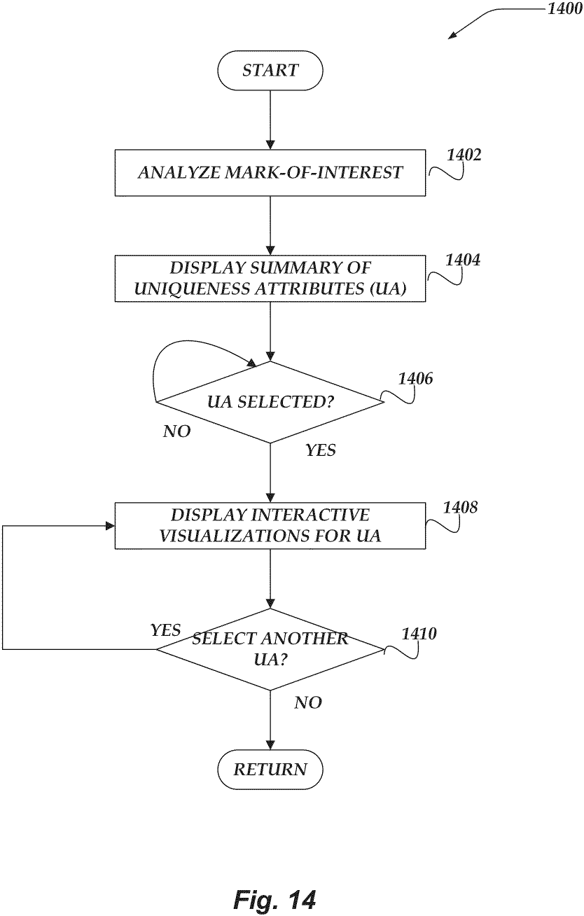

FIG. 14 illustrates a flowchart for process 1400 for user interfaces for analyzing data based on visualization features in accordance with one or more of the various embodiments. After a start block at 1402, in one or more of the various embodiments, evaluation engines may be arranged to analyze the mark-of-interest. At block 1404, in one or more of the various embodiments, evaluation engines may be arranged to display a summary of attributes that may be unique to the mark-of-interest. At decision block 1406, in one or more of the various embodiments, if a unique attribute may be selected, control may flow to block 1408; otherwise, control may loop back to decision block 1406. At block 1408, in one or more of the various embodiments, evaluation engines may be arranged to display one or more interactive visualizations associated with the selected unique attribute. In some embodiments, the one or more interactive visualizations may enable users to view one or more values, fields, records, or the like, that may be associated with the uniqueness attributes or the mark-of-interest. At decision block 1410, in one or more of the various embodiments, if another unique attribute may be selected, control may flow to block 1408; otherwise, control may be returned to a calling process.

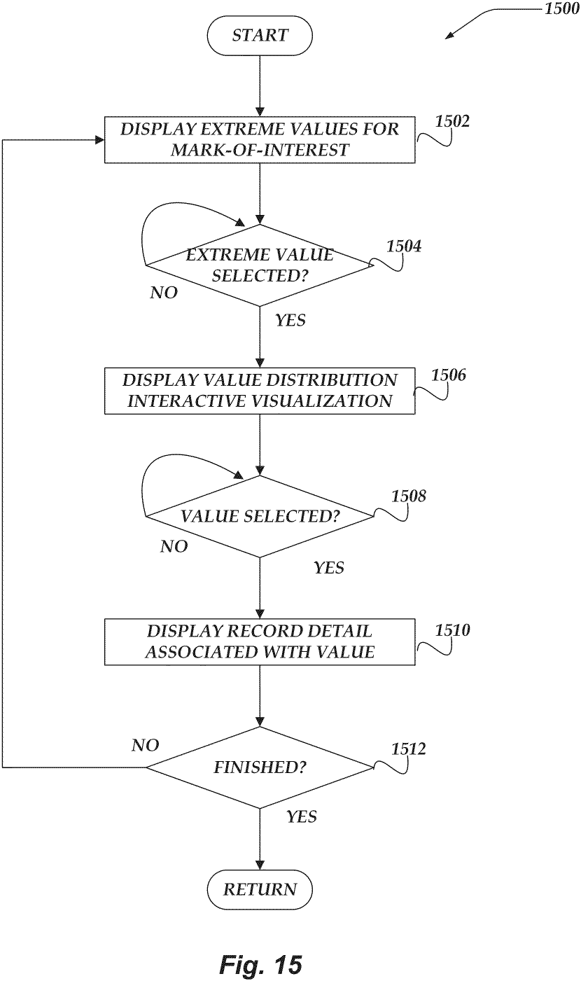

FIG. 15 illustrates a flowchart for process 1500 for user interfaces for analyzing data based on visualization features in accordance with one or more of the various embodiments. After a start block at 1502, in one or more of the various embodiments, evaluation engines may be arranged to display one or more extreme values of the mark-of-interest. At decision block 1504, in one or more of the various embodiments, if a user selected one of the extreme values, control may flow to block 1506; otherwise, control may loop back to decision block 1504. At block 1506, in one or more of the various embodiments, evaluation engines may be arranged to display an interactive visualization that shows the value distribution for the selected value. At decision block 1508, in one or more of the various embodiments, if a value in the value distribute visualization may be selected, control may flow to block 1510; otherwise, control may loop back to block 1508. At block 1510, in one or more of the various embodiments, evaluation engines may be arranged to display detail information that may be associated with the record(s) that may correspond to the selected value. At decision block 1512, in one or more of the various embodiments, if the user may be finished examining the selected extreme values, control may be returned to a calling process; otherwise, control may loop back to block 1502.

It will be understood that each block in each flowchart illustration, and combinations of blocks in each flowchart illustration, can be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as might arise in a multi-processor computer system. In addition, one or more blocks or combinations of blocks in each flowchart illustration may also be performed concurrently with other blocks or combinations of blocks, or even in a different sequence than illustrated without departing from the scope or spirit of the invention.

Accordingly, each block in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, can be implemented by special purpose hardware based systems, which perform the specified actions or steps, or combinations of special purpose hardware and computer instructions. The foregoing example should not be construed as limiting or exhaustive, but rather, an illustrative use case to show an implementation of at least one of the various embodiments of the invention.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiment, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

### Illustrated Operating Environment

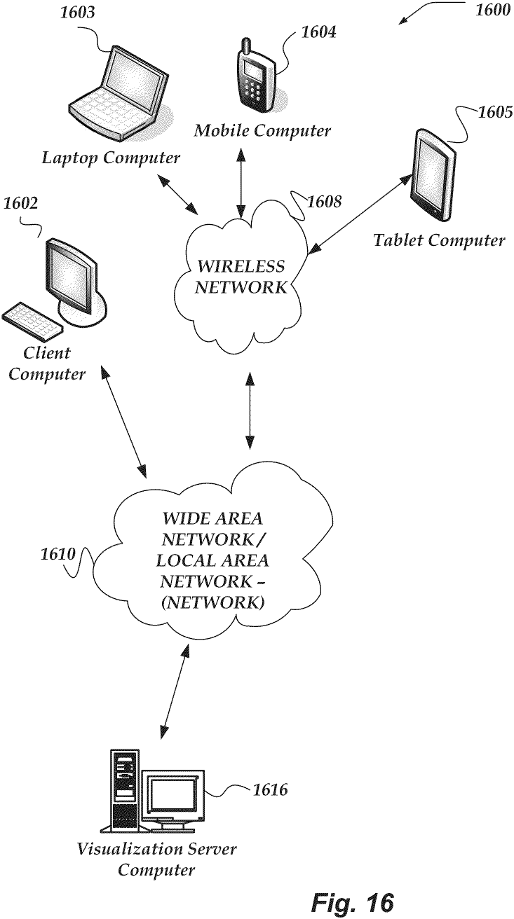

FIG. 16 shows components of one embodiment of an environment in which embodiments of the invention may be practiced in accordance with one or more of the various embodiments. Not all of the components may be required to practice the one or more embodiments., and variations in the arrangement and type of the components may be made without departing from the spirit or scope of the innovation disclosed herein. As shown, system 1600 of FIG. 16 includes local area networks (LANs)/ wide area networks (WANs) – (network) 1610, wireless network 1608, client computers 1602-1605, visualization server computer 1616, or the like.

At least one embodiment of client computers 1602-1605 is described in more detail below in conjunction with FIG. 2. In one embodiment, at least some of client computers 1602-1605 may operate over one or more wired or wireless networks, such as networks 1608, or 1610. Generally, client computers 1602-1605 may include virtually any computer capable of communicating over a network to send and receive information, perform various online activities, offline actions, or the like. In one embodiment, one or more of client computers 1602-1605 may be configured to operate within a business or other entity to perform a variety of services for the business or other entity. For example, client computers 1602-1605 may be configured to operate as a web server, firewall, client application, media player, mobile telephone, game console, desktop computer, or the like. However, client computers 1602-1605 are not constrained to these services and may also be employed, for example, as for end-user computing in other embodiments. It should be recognized that more or less client computers (as shown in FIG. 16) may be included within a system such as described herein, and embodiments are therefore not constrained by the number or type of client computers employed.

Computers that may operate as client computer 1602 may include computers that typically connect using a wired or wireless communications medium such as personal computers, multiprocessor systems, microprocessor-based or programmable electronic devices, network PCs, or the like. In some embodiments, client computers 1602-1605 may include virtually any portable computer capable of connecting to another computer and receiving information such as, laptop computer 1603, mobile computer 1604, tablet computers 1605, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 1602-1605 typically range widely in terms of capabilities and features. Moreover, client computers 1602-1605 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one embodiment, the browser application is enabled to employ JavaScript, HyperText Markup Language (HTML), eXtensible Markup Language (XML), JavaScript Object Notation (JSON), Cascading Style Sheets (CSS), or the like, or combination thereof, to display and send a message. In one embodiment, a user of the client computer may employ the browser application to perform various activities over a network (online). However, another application may also be used to perform various online activities.

Client computers 1602-1605 also may include at least one other client application that is configured to receive or send content between another computer. The client application may include a capability to send or receive content, or the like. The client application may further provide information that identifies itself, including a type, capability, name, and the like. In one embodiment, client computers 1602-1605 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, visualization server computer 1616, or other computers.

Client computers 1602-1605 may further be configured to include a client application that enables an end-user to log into an end-user account that may be managed by another computer, such as visualization server computer 1616, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Also, client computers may be arranged to enable users to display reports, interactive user-interfaces, or results provided by visualization server computer 1616.

Wireless network 1608 is configured to couple client computers 1603-1605 and its components with network 1610. Wireless network 1608 may include any of a variety of wireless sub-networks that may further overlay stand-alone ad-hoc networks, and the like, to provide an infrastructure-oriented connection for client computers 1603-1605. Such sub-networks may include mesh networks, Wireless LAN (WLAN) networks, cellular networks, and the like. In one embodiment, the system may include more than one wireless network.

Wireless network 1608 may further include an autonomous system of terminals, gateways, routers, and the like connected by wireless radio links, and the like. These connectors may be configured to move freely and randomly and organize themselves arbitrarily, such that the topology of wireless network 1608 may change rapidly.

Wireless network 1608 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 1603-1605 with various degrees of mobility. In one non-limiting example, wireless network 1608 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 1608 may include virtually any wireless communication mechanism by which information may travel between client computers 1603-1605 and another computer, network, a cloud-based network, a cloud instance, or the like.

Network 1610 is configured to couple network computers with other computers, including, visualization server computer 1616, client computers 1602, and client computers 1603-1605 through wireless network 1608, or the like. Network 1610 is enabled to employ any form of computer readable media for communicating information from one electronic device to another. Also, network 1610 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 1610 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

Also, one embodiment of visualization server computer 1616 is described in more detail below in conjunction with FIG. 18. Although FIG. 16 illustrates visualization server computer 1616 as a single computer, the innovations or embodiments are not so limited. For example, one or more functions of visualization server computer 1616, or the like, may be distributed across one or more distinct network computers. Moreover, in one or more embodiments, visualization server computer 1616 may be implemented using a plurality of network computers. Further, in one or more of the various embodiments, visualization server computer 1616, or the like, may be implemented using one or more cloud instances in one or more cloud networks. Accordingly, these innovations and embodiments are not to be construed as being limited to a single environment, and other configurations, and other architectures are also envisaged.

### Illustrative Client Computer

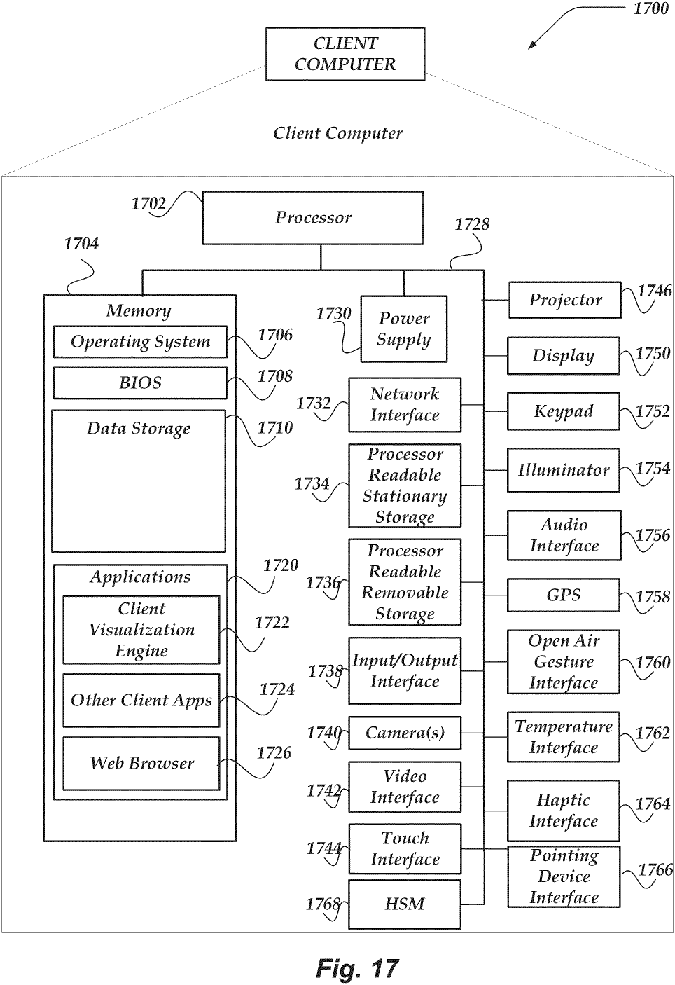

FIG. 17 shows one embodiment of client computer 1700 in accordance with one or more of the various embodiments. In some embodiments, client computers may include many more or less components than those shown. Client computer 1700 may represent, for example, one or more embodiment of mobile computers or client computers shown in FIG. 1.

Client computer 1700 may include processor 1702 in communication with memory 1704 via bus 1728. Client computer 1700 may also include power supply 1730, network interface 1732, audio interface 1756, display 1750, keypad 1752, illuminator 1754, video interface 1742, input/output interface 1738, haptic interface 1764, global positioning systems (GPS) receiver 1758, open air gesture interface 1760, temperature interface 1762, camera(s) 1740, projector 1746, pointing device interface 1766, processor-readable stationary storage device 1734, and processor-readable removable storage device 1736. Client computer 1700 may optionally communicate with a base station (not shown), or directly with another computer. And in one embodiment, although not shown, a gyroscope may be employed within client computer 1700 to measuring or maintaining an orientation of client computer 1700.

Power supply 1730 may provide power to client computer 1700. A rechargeable or non-rechargeable battery may be used to provide power. The power may also be provided by an external power source, such as an AC adapter or a powered docking cradle that supplements or recharges the battery.

Network interface 1732 includes circuitry for coupling client computer 1700 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 1732 is sometimes known as a transceiver, transceiving device, or network interface card (NIC).

Audio interface 1756 may be arranged to produce and receive audio signals such as the sound of a human voice. For example, audio interface 1756 may be coupled to a speaker and microphone (not shown) to enable telecommunication with others or generate an audio acknowledgment for some action. A microphone in audio interface 1756 can also be used for input to or control of client computer 1700, e.g., using voice recognition, detecting touch based on sound, and the like.

Display 1750 may be a liquid crystal display (LCD), gas plasma, electronic ink, light emitting diode (LED), Organic LED (OLED) or any other type of light reflective or light transmissive display that can be used with a computer. Display 1750 may also include a touch interface 1744 arranged to receive input from an object such as a stylus or a digit from a human hand, and may use resistive, capacitive, surface acoustic wave (SAW), infrared, radar, or other technologies to sense touch or gestures.

Projector 1746 may be a remote handheld projector or an integrated projector that is capable of projecting an image on a remote wall or any other reflective object such as a remote screen.

Video interface 1742 may be arranged to capture video images, such as a still photo, a video segment, an infrared video, or the like. For example, video interface 1742 may be coupled to a digital video camera, a web-camera, or the like. Video interface 1742 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 1752 may comprise any input device arranged to receive input from a user. For example, keypad 1752 may include a push button numeric dial, or a keyboard. Keypad 1752 may also include command buttons that are associated with selecting and sending images.

Illuminator 1754 may provide a status indication or provide light. Illuminator 1754 may remain active for specific periods of time or in response to event messages. For example, when illuminator 1754 is active, it may backlight the buttons on keypad 1752 and stay on while the client computer is powered. Also, illuminator 1754 may backlight these buttons in various patterns when particular actions are performed, such as dialing another client computer. Illuminator 1754 may also cause light sources positioned within a transparent or translucent case of the client computer to illuminate in response to actions.

Further, client computer 1700 may also comprise hardware security module (HSM) 1768 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 1768 may be a stand-alone computer, in other cases, HSM 1768 may be arranged as a hardware card that may be added to a client computer.

Client computer 1700 may also comprise input/output interface 1738 for communicating with external peripheral devices or other computers such as other client computers and network computers. The peripheral devices may include an audio headset, virtual reality headsets, display screen glasses, remote speaker system, remote speaker and microphone system, and the like. Input/output interface 1738 can utilize one or more technologies, such as Universal Serial Bus (USB), Infrared, WiFi, WiMax, Bluetooth™, and the like.

Input/output interface 1738 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 1700.

Haptic interface 1764 may be arranged to provide tactile feedback to a user of the client computer. For example, the haptic interface 1764 may be employed to vibrate client computer 1700 in a particular way when another user of a computer is calling. Temperature interface 1762 may be used to provide a temperature measurement input or a temperature changing output to a user of client computer 1700. Open air gesture interface 1760 may sense physical gestures of a user of client computer 1700, for example, by using single or stereo video cameras, radar, a gyroscopic sensor inside a computer held or worn by the user, or the like. Camera 1740 may be used to track physical eye movements of a user of client computer 1700.

GPS transceiver 1758 can determine the physical coordinates of client computer 1700 on the surface of the Earth, which typically outputs a location as latitude and longitude values. GPS transceiver 1758 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 1700 on the surface of the Earth. It is understood that under different conditions, GPS transceiver 1758 can determine a physical location for client computer 1700. In one or more embodiment, however, client computer 1700 may, through other components, provide other information that may be employed to determine a physical location of the client computer, including for example, a Media Access Control (MAC) address, IP address, and the like.

In at least one of the various embodiments, applications, such as, operating system 1706, client visualization engine 1722, other client apps 1724, web browser 1726, or the like, may be arranged to employ geo-location information to select one or more localization features, such as, time zones, languages, currencies, calendar formatting, or the like. Localization features may be used in documents, visualizations, display objects, display models, action objects, user-interfaces, reports, as well as internal processes or databases. In at least one of the various embodiments, geo-location information used for selecting localization information may be provided by GPS 1758. Also, in some embodiments, geolocation information may include information provided using one or more geolocation protocols over the networks, such as, wireless network 108 or network 111.

Human interface components can be peripheral devices that are physically separate from client computer 1700, allowing for remote input or output to client computer 1700. For example, information routed as described here through human interface components such as display 1750 or keyboard 1752 can instead be routed through network interface 1732 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client computer with such peripheral human interface components is a wearable computer, which might include a remote pico projector along with one or more cameras that remotely communicate with a separately located client computer to sense a user’s gestures toward portions of an image projected by the pico projector onto a reflected surface such as a wall or the user’s hand.

A client computer may include web browser application 1726 that is configured to receive and to send web pages, web-based messages, graphics, text, multimedia, and the like. The client computer’s browser application may employ virtually any programming language, including a wireless application protocol messages (WAP), and the like. In one or more embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 1704 may include RAM, ROM, or other types of memory. Memory 1704 illustrates an example of computer-readable storage media (devices) for storage of information such as computer-readable instructions, data structures, program modules or other data. Memory 1704 may store BIOS 1708 for controlling low-level operation of client computer 1700. The memory may also store operating system 1706 for controlling the operation of client computer 1700. It will be appreciated that this component may include a general-purpose operating system such as a version of UNIX®, or Linux®, Microsoft Windows® or a specialized client computer communication operating system such as, Android™, or the Apple® Corporation’s iOS. The operating system may include, or interface with a Java virtual machine module that enables control of hardware components or operating system operations via Java application programs.

Memory 1704 may further include one or more data storage 1710, which can be utilized by client computer 1700 to store, among other things, applications 1720 or other data. For example, data storage 1710 may also be employed to store information that describes various capabilities of client computer 1700. The information may then be provided to another device or computer based on any of a variety of methods, including being sent as part of a header during a communication, sent upon request, or the like. Data storage 1710 may also be employed to store social networking information including address books, buddy lists, aliases, user profile information, or the like. Data storage 1710 may further include program code, data, algorithms, and the like, for use by a processor, such as processor 1702 to execute and perform actions. In one embodiment, at least some of data storage 1710 might also be stored on another component of client computer 1700, including, but not limited to, non-transitory processor-readable removable storage device 1736, processor-readable stationary storage device 1734, or even external to the client computer.

Applications 1720 may include computer executable instructions which, when executed by client computer 1700, transmit, receive, or otherwise process instructions and data. Applications 1720 may include, for example, client display engine 1722, other client applications 1724, web browser 1726, or the like. Client computers may be arranged to exchange communications, such as, queries, searches, messages, notification messages, event messages, alerts, performance metrics, log data, API calls, or the like, combination thereof, with visualization server computers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), client computer 1700 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 1700 may include one or more hardware microcontrollers instead of CPUs. In one or more embodiment, the one or more microcontrollers may directly execute their own embedded logic to perform actions and access its own internal memory and its own external Input and Output Interfaces (e.g., hardware pins or wireless transceivers) to perform actions, such as System On a Chip (SOC), or the like.

### Illustrative Network Computer

FIG. 18 shows one embodiment of network computer 1800 that may be included in a system implementing one or more of the various embodiments in accordance with one or more of the various embodiments. Network computer 1800 may include many more or less components than those shown in FIG. 18. However, the components shown are sufficient to disclose an illustrative embodiment for practicing these innovations. Network computer 1800 may represent, for example, one embodiment of one or more visualization server computer 116 of FIG. 1.

Network computers, such as, network computer 1800 may include a processor 1802 that may be in communication with a memory 1804 via a bus 1828. In some embodiments, processor 1802 may be comprised of one or more hardware processors, or one or more processor cores. In some cases, one or more of the one or more processors may be specialized processors designed to perform one or more specialized actions, such as, those described herein. Network computer 1800 also includes a power supply 1830, network interface 1832, audio interface 1856, display 1850, keyboard 1852, input/output interface 1838, processor-readable stationary storage device 1834, and processor-readable removable storage device 1836. Power supply 1830 provides power to network computer 1800.

Network interface 1832 includes circuitry for coupling network computer 1800 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 1832 is sometimes known as a transceiver, transceiving device, or network interface card (NIC). Network computer 1800 may optionally communicate with a base station (not shown), or directly with another computer.

Audio interface 1856 is arranged to produce and receive audio signals such as the sound of a human voice. For example, audio interface 1856 may be coupled to a speaker and microphone (not shown) to enable telecommunication with others or generate an audio acknowledgment for some action. A microphone in audio interface 1856 can also be used for input to or control of network computer 1800, for example, using voice recognition.

Display 1850 may be a liquid crystal display (LCD), gas plasma, electronic ink, light emitting diode (LED), Organic LED (OLED) or any other type of light reflective or light transmissive display that can be used with a computer. In some embodiments, display 1850 may be a handheld projector or pico projector capable of projecting an image on a wall or other object.

Network computer 1800 may also comprise input/output interface 1838 for communicating with external devices or computers not shown in FIG. 18. Input/output interface 1838 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 1838 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 1800. Human interface components can be physically separate from network computer 1800, allowing for remote input or output to network computer 1800. For example, information routed as described here through human interface components such as display 1850 or keyboard 1852 can instead be routed through the network interface 1832 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 1858 to receive user input.

GPS transceiver 1840 can determine the physical coordinates of network computer 1800 on the surface of the Earth, which typically outputs a location as latitude and longitude values. GPS transceiver 1840 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 1800 on the surface of the Earth. It is understood that under different conditions, GPS transceiver 1840 can determine a physical location for network computer 1800. In one or more embodiments, however, network computer 1800 may, through other components, provide other information that may be employed to determine a physical location of the client computer, including for example, a Media Access Control (MAC) address, IP address, and the like.

In at least one of the various embodiments, applications, such as, operating system 1806, evaluation engine 1822, visualization engine 1824, modeling engine 1826, other applications 1829, or the like, may be arranged to employ geo-location information to select one or more localization features, such as, time zones, languages, currencies, currency formatting, calendar formatting, or the like. Localization features may be used in documents, file systems, user-interfaces, reports, display objects, display models, visualizations as well as internal processes or databases. In at least one of the various embodiments, geo-location information used for selecting localization information may be provided by GPS 1840. Also, in some embodiments, geolocation information may include information provided using one or more geolocation protocols over the networks, such as, wireless network 108 or network 111.

Memory 1804 may include Random Access Memory (RAM), Read-Only Memory (ROM), or other types of memory. Memory 1804 illustrates an example of computer-readable storage media (devices) for storage of information such as computer-readable instructions, data structures, program modules or other data. Memory 1804 stores a basic input/output system (BIOS) 1808 for controlling low-level operation of network computer 1800. The memory also stores an operating system 1806 for controlling the operation of network computer 1800. It will be appreciated that this component may include a general-purpose operating system such as a version of UNIX, or Linux®, or a specialized operating system such as Microsoft Corporation’s Windows® operating system, or the Apple Corporation’s OSX® operating system. The operating system may include, or interface with one or more virtual machine modules, such as, a Java virtual machine module that enables control of hardware components or operating system operations via Java application programs. Likewise, other runtime environments may be included.

Memory 1804 may further include one or more data storage 1810, which can be utilized by network computer 1800 to store, among other things, applications 1820 or other data. For example, data storage 1810 may also be employed to store information that describes various capabilities of network computer 1800. The information may then be provided to another device or computer based on any of a variety of methods, including being sent as part of a header during a communication, sent upon request, or the like. Data storage 1810 may also be employed to store social networking information including address books, buddy lists, aliases, user profile information, or the like. Data storage 1810 may further include program code, data, algorithms, and the like, for use by a processor, such as processor 1802 to execute and perform actions such as those actions described below. In one embodiment, at least some of data storage 1810 might also be stored on another component of network computer 1800, including, but not limited to, non-transitory media inside processor-readable removable storage device 1836, processor-readable stationary storage device 1834, or any other computer-readable storage device within network computer 1800, or even external to network computer 1800. Data storage 1810 may include, for example, data models 1814, data sources 1816, visualization models 1818, mark evaluators 1819, or the like.

Applications 1820 may include computer executable instructions which, when executed by network computer 1800, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 1820 may include evaluation engine 1822, visualization engine 1824, modeling engine 1826, other applications 1829, or the like, that may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, evaluation engine 1822, visualization engine 1824, modeling engine 1826, other applications 1829, or the like, may be operative in a cloud-based computing environment. In one or more of the various embodiments, these applications, and others, that comprise the management platform may be executing within virtual machines or virtual servers that may be managed in a cloud-based based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to evaluation engine 1822, visualization engine 1824, modeling engine 1826, other applications 1829, or the like, may be provisioned and de-commissioned automatically.

Also, in one or more of the various embodiments, evaluation engine 1822, visualization engine 1824, modeling engine 1826, other applications 1829, or the like, may be located in virtual servers running in a cloud-based computing environment rather than being tied to one or more specific physical network computers.

Further, network computer 1800 may also include hardware security module (HSM) 1860 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 1860 may be a stand-alone network computer, in other cases, HSM 1860 may be arranged as a hardware card that may be installed in a network computer.

Additionally, in one or more embodiments (not shown in the figures), network computer 1800 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of a CPU. In one or more embodiment, the one or more microcontrollers may directly execute their own embedded logic to perform actions and access their own internal memory and their own external input and Output Interfaces (e.g., hardware pins or wireless transceivers) to perform actions, such as System On a Chip (SOC), or the like.

What is claimed as new and desired to be protected by letters patent of the united states is:

1. A method for managing visualizations of data using one or more processors that are configured to execute instructions, wherein the instructions perform actions, comprising:
providing a visualization based on data from a data source, wherein the visualization includes one or more marks that are associated with one or more values from the data source; and
in response to a determination of a mark-of-interest from the one or more marks, generating a user-interface to display one or more evaluation results that are associated with the mark-of-interest and performing further actions, including:
displaying one or more explanation narratives that are associated with the mark-of-interest;
displaying one or more explanation visualizations that are associated with the mark-of-interest, wherein the one or more explanation visualizations are separate from the visualization;
in response to a selection of an explanation narrative, displaying one or more characteristics of the mark-of-interest that correspond to the explanation narrative; and
in response to a selection of an explanation visualization, displaying one or more other characteristics of the mark-of-interest that correspond to the explanation visualization; and
in response to providing another visualization that includes one or more other marks, preserving the display of the one or more evaluation results that are associated with the mark-of-interest; and
in response to a determination of another mark-of-interest, updating the display of the one or more evaluation results based on the other mark-of-interest.

2. The method of claim 1, wherein displaying the one or more other characteristics of the mark-of-interest that correspond to the explanation narrative, further comprises:
displaying one or more additional explanation narratives based on an evaluation result that corresponds to the explanation narrative.

3. The method of claim 1, wherein displaying the one or more other characteristics of the mark-of-interest that correspond to the explanation visualization, further comprises:
displaying one or more additional explanation visualizations based on an evaluation result that corresponds to the explanation visualization, wherein the one or more additional explanation visualizations include one or more interactive features that enable users to one or more of filter, expand, or view one or more of a value, a field, or a record from the data source that are associated with the mark-of-interest.

4. The method of claim 1, wherein generating the user-interface to display the one or more evaluation results, further comprises:
categorizing the one or more evaluation results based on the one or more characteristics of the mark-of-interest that correspond to the one or more evaluation results; and
displaying one or more portions of the one or more explanation narratives in one or more portions of the user interface associated with one or more result categories;.

5. The method of claim 1, wherein generating the user-interface to display the one or more evaluation results, further comprises:
displaying a summary of one or more uniqueness attributes associated with the mark-of-interest; and
in response to a selection of a uniqueness attribute, displaying an interactive visualization of the selected uniqueness attribute, wherein the interactive visualization enables a view of one or more of a value, a field, or a record associated with the uniqueness attribute or the mark-of-interest.

6. The method of claim 1, wherein generating the user-interface to display the one or more evaluation results, further comprises:
providing a summary view that displays a summary of information associated with one or more of the mark-of-interest or the visualization, wherein the summary of information associated with the visualization, includes a view of the visualization scaled to fit within the user interface that displays the one or more evaluation results.

7. The method of claim 4, further comprising:
in response to providing the other visualization, preserving the display of the scaled view of the visualization in the user interface.

8. A processor readable non-transitory storage media that includes instructions for managing visualizations of data, wherein execution of the instructions by one or more processors, performs actions, comprising:
providing a visualization based on data from a data source, wherein the visualization includes one or more marks that are associated with one or more values from the data source; and
in response to a determination of a mark-of-interest from the one or more marks, generating a user-interface to display one or more evaluation results that are associated with the mark-of-interest and performing further actions, including:
displaying one or more explanation narratives that are associated with the mark-of-interest;
displaying one or more explanation visualizations that are associated with the mark-of-interest, wherein the one or more explanation visualizations are separate from the visualization;
in response to a selection of an explanation narrative, displaying one or more characteristics of the mark-of-interest that correspond to the explanation narrative; and
in response to a selection of an explanation visualization, displaying one or more other characteristics of the mark-of-interest that correspond to the explanation visualization; and
in response to providing another visualization that includes one or more other marks, preserving the display of the one or more evaluation results that are associated with the mark-of-interest; and
in response to a determination of another mark-of-interest, updating the display of the one or more evaluation results based on the other mark-of-interest.

9. The media of claim 8, wherein displaying the one or more other characteristics of the mark-of-interest that correspond to the explanation narrative, further comprises:
displaying one or more additional explanation narratives based on an evaluation result that corresponds to the explanation narrative.

10. The media of claim 8, wherein displaying the one or more other characteristics of the mark-of-interest that correspond to the explanation visualization, further comprises:
displaying one or more additional explanation visualizations based on an evaluation result that corresponds to the explanation visualization, wherein the one or more additional explanation visualizations include one or more interactive features that enable users to one or more of filter, expand, or view one or more of a value, a field, or a record from the data source that are associated with the mark-of-interest.

11. The media of claim 8, wherein generating the user-interface to display the one or more evaluation results, further comprises:
categorizing the one or more evaluation results based on the one or more characteristics of the mark-of-interest that correspond to the one or more evaluation results; and
displaying one or more portions of the one or more explanation narratives in one or more portions of the user interface associated with one or more result categories;.

12. The media of claim 8, wherein generating the user-interface to display the one or more evaluation results, further comprises:
displaying a summary of one or more uniqueness attributes associated with the mark-of-interest; and
in response to a selection of a uniqueness attribute, displaying an interactive visualization of the selected uniqueness attribute, wherein the interactive visualization enables a view of one or more of a value, a field, or a record associated with the uniqueness attribute or the mark-of-interest.

13. The media of claim 8, wherein generating the user-interface to display the one or more evaluation results, further comprises:
providing a summary view that displays a summary of information associated with one or more of the mark-of-interest or the visualization, wherein the summary of information associated with the visualization, includes a view of the visualization scaled to fit within the user interface that displays the one or more evaluation results.

14. The media of claim 13, further comprising:
in response to providing the other visualization, preserving the display of the scaled view of the visualization in the user interface.

15. A system for managing visualizations, comprising:
a network computer, comprising:
a memory that stores at least instructions; and
one or more processors that execute instructions that perform actions, including:
providing a visualization based on data from a data source, wherein the visualization includes one or more marks that are associated with one or more values from the data source; and
in response to a determination of a mark-of-interest from the one or more marks, generating a user-interface to display one or more evaluation results that are associated with the mark-of-interest and performing further actions, including:
displaying one or more explanation narratives that are associated with the mark-of-interest;
displaying one or more explanation visualizations that are associated with the mark-of-interest, wherein the one or more explanation visualizations are separate from the visualization;
in response to a selection of an explanation narrative, displaying one or more characteristics of the mark-of-interest that correspond to the explanation narrative; and
in response to a selection of an explanation visualization, displaying one or more other characteristics of the mark-of-interest that correspond to the explanation visualization; and
in response to providing another visualization that includes one or more other marks, preserving the display of the one or more evaluation results that are associated with the mark-of-interest; and
in response to a determination of another mark-of-interest, updating the display of the one or more evaluation results based on the other mark-of-interest; and
a client computer, comprising:
a memory that stores at least instructions; and
one or more processors that execute instructions that perform actions, including:
displaying one or more of the visualization or the report on a hardware display.

16. The system of claim 15, wherein displaying the one or more other characteristics of the mark-of-interest that correspond to the explanation narrative, further comprises:
displaying one or more additional explanation narratives based on an evaluation result that corresponds to the explanation narrative.

17. The system of claim 15, wherein displaying the one or more other characteristics of the mark-of-interest that correspond to the explanation visualization, further comprises:
displaying one or more additional explanation visualizations based on an evaluation result that corresponds to the explanation visualization, wherein the one or more additional explanation visualizations include one or more interactive features that enable users to one or more of filter, expand, or view one or more of a value, a field, or a record from the data source that are associated with the mark-of-interest.

18. The system of claim 15, wherein generating the user-interface to display the one or more evaluation results, further comprises:
categorizing the one or more evaluation results based on the one or more characteristics of the mark-of-interest that correspond to the one or more evaluation results; and
displaying one or more portions of the one or more explanation narratives in one or more portions of the user interface associated with one or more result categories;.

19. The system of claim 15, wherein generating the user-interface to display the one or more evaluation results, further comprises:
displaying a summary of one or more uniqueness attributes associated with the mark-of-interest; and
in response to a selection of a uniqueness attribute, displaying an interactive visualization of the selected uniqueness attribute, wherein the interactive visualization enables a view of one or more of a value, a field, or a record associated with the uniqueness attribute or the mark-of-interest.

20. The system of claim 15, wherein generating the user-interface to display the one or more evaluation results, further comprises:
providing a summary view that displays a summary of information associated with one or more of the mark-of-interest or the visualization, wherein the summary of information associated with the visualization, includes a view of the visualization scaled to fit within the user interface that displays the one or more evaluation results.
